(19) United States
(12) Patent Application Publication
(10) Pub. No.: US 2024/0275554 A1
(43) Pub. Date: Aug. 15, 2024

(54) METHOD AND DEVICE IN NODES USED FOR WIRELESS COMMUNICATION

(71) Applicants: Qi JIANG, Shanghai (CN); Xiaobo ZHANG, Shanghai (CN)

(72) Inventors: Qi JIANG, Shanghai (CN); Xiaobo ZHANG, Shanghai (CN)

(73) Assignee: SHANGHAI LANGBO COMMUNICATION TECHNOLOGY COMPANY LIMITED, Shanghai, OT (CN)

(21) Appl. No.: 18/644,073

(22) Filed: Apr. 23, 2024

Related U.S. Application Data
(63) Continuation of application No. PCT/CN2022/125857, filed on Oct. 18, 2022.

(30) Foreign Application Priority Data
Oct. 29, 2021 (CN) 202111276054.7

(51) Int. Cl. H04L 5/00; H04W 72/044

(52) U.S. Cl. CPC H04L 5/0051; H04W 72/044

(57) ABSTRACT

The node receives a first information block, the first information block indicating a target identity; and receives or transmits a first signal in a first resource set, the first signal being QCL with a first target reference signal resource; the target identity is associated with K1 first-type reference signal resources, the K1 first-type reference signal resources being associated with a first cell; the first target reference signal resource is one of the K1 first-type reference signal resources; the first resource set belongs to the first cell; the first resource set is used to determine the first target reference signal resource from the K1 first-type reference signal resources. The present application improves the determination of TCI, and thus the transmission of beamforming with a spectrum configuration based on flexible duplex mode or variable link, hence the optimized system performance.

### CROSS REFERENCE TO RELATED APPLICATIONS

This application is the continuation of the international patent application No. PCT/CN2022/125857, filed on Oct. 18, 2022, and claims the priority benefit of Chinese Patent Application No. 202111276054.7, filed on Oct. 29, 2021, the full disclosure of which is incorporated herein by reference.

### BACKGROUND

### Technical Field

The present application relates to transmission methods and devices in wireless communication systems, and in particular to a transmission scheme and device for flexible transmission direction configurations in wireless communications.

### Related Art

Application scenarios of future wireless communication systems are becoming increasingly diversified, and different application scenarios have different performance demands on systems. In order to meet different performance requirements of various application scenarios, the 3rd Generation Partner Project (3GPP) Radio Access Network (RAN) #72 plenary decided to conduct the study of New Radio (NR), or what is called fifth Generation (5G). The work Item (WI) of NR was approved at the 3GPP RAN #75 session to standardize the NR. It was decided at the 3GPP RAN #86 Plenary that the Study Item (SI) and the Work Item (WI) of NR Rel-17 should be started, and the SI and WI of NR Rel-18 are expected to be proposed at the 3GPP RAN #94e plenary.

Enhanced Mobile BroadBand (eMBB), Ultra-reliable and Low Latency Communications (URLLC) and massive Machine Type Communications (mMTC) are three major application scenarios in New Radio (NR) technology. In the NR Rel-16 system, a major difference compared to the Long-Term Evolution (LTE) and Long-Term Evolution Advanced (LTE-A) frame structures is that the symbols in a slot can be configured as Downlink, Uplink, or Flexible. For a symbol configured as “Flexible”, the terminal receives downlink transmission on that symbol, and that symbol can also be used for uplink scheduling. The above approach is more flexible than LTE and LTE-A systems.

### SUMMARY

In existing NR systems, the concepts of unified Transmission Configuration Indication (TCI) and common TCI are proposed to reduce signaling overhead. Among them, the unified TCI means that for a terminal, two different physical channels can share the same Quasi Co-location (QCL) relationship, and the QCL relationships corresponding to the two different physical channels can be updated or activated at the same time; and the common TCI means that multiple carriers can share a TCI-State ID, i.e., a single TCI-StateId can simultaneously update or activate the QCL relationships of multiple physical channels on multiple carriers. However, when the uplink and downlink configurations in the system become more flexible, especially for the base station, downlink and uplink transmissions are performed simultaneously on different frequency bands in the same time slot. Under such circumstance, the environment of interference confronting beamforming-based transmission will get more complicated, such that the existing approach in which the unified TCI, as well as common TCI, are updated or activated needs to be redesigned.

To address the issue of configuration of link directions in cases supporting Flexible Duplex Mode, the present application provides a solution. It should be noted that in the description of the present application, the flexible duplex mode is only taken as a typical application scenario or example; the present application is equally applicable to other scenarios confronting similar issues, for instance, scenarios in which there is a change of link direction, or scenarios supporting multi-stage configuration of transmission directions, or those equipped with a more capable base station or UE, such as a base station or UE that supports intra-frequency full duplex scenarios or is targeted for various application scenarios like eMBB and URLLC, where similar technical effects can be achieved. Additionally, the adoption of a unified solution for various scenarios, including but not limited to eMBB and URLLC scenarios, contributes to the reduction of hardcore complexity and costs. In the case of no conflict, the embodiments of a first node and the characteristics in the embodiments may be applied to a second node, and vice versa. Particularly, for interpretations of the terminology, nouns, functions and variables (unless otherwise specified) in the present application, refer to definitions given in TS36 series, TS38 series and TS37 series of 3GPP specifications.

The present application provides a method in a first node for wireless communications, comprising:
receiving a first information block, the first information block indicating a target identity; and
receiving a first signal in a first resource set, with a demodulation reference signal (DMRS) of a channel occupied by the first signal being quasi co-located with a first target reference signal resource;
herein, the target identity is associated with K1 first-type reference signal resources, and the K1 first-type reference signal resources are associated with a first cell, K1 being a positive integer greater than 1; the first target reference signal resource is one of the K1 first-type reference signal resources; a frequency-domain resource occupied by the first resource set belongs to the first cell; at least one of a time-domain resource occupied by the first resource set or the frequency-domain resource occupied by the first resource set is used to determine the first target reference signal resource from the K1 first-type reference signal resources.

The present application provides a method in a first node for wireless communications, comprising:
receiving a first information block, the first information block indicating a target identity; and
transmitting a first signal in a first resource set, with a demodulation reference signal (DMRS) of a channel occupied by the first signal being quasi co-located with a first target reference signal resource;
herein, the target identity is associated with K1 first-type reference signal resources, and the K1 first-type reference signal resources are associated with a first cell, K1 being a positive integer greater than 1; the first target reference signal resource is one of the K1 first-type reference signal resources; a frequency-domain resource occupied by the first resource set belongs to the first cell; at least one of a time-domain resource occupied by the first resource set or the frequency-domain resource occupied by the first resource set is used to determine the first target reference signal resource from the K1 first-type reference signal resources.

In one embodiment, a technical feature of the above method is that the K1 first-type reference signals correspond to K1 QCL relationships that can be indicated by a TCI-StateId associated to a carrier, and the K1 QCL relationships are used for different interference situations, respectively. For example, when the first signal is located in resources supporting full duplex, the target identity indicates one of the K1 QCL relationships to avoid particular interference situations that may arise in a full-duplex scenario; when the first signal is located outside of the resources supporting full duplex, the target identity indicates another one of the K1 QCL relationships to maximize the system performance.

According to one aspect of the present application, the target identity is associated with any candidate reference signal resource set of Q1 candidate reference signal resource sets, the Q1 candidate reference signal resource sets being associated with Q2 cells; a first reference signal resource set comprises the K1 first-type reference signal resources; the first reference signal resource set is one of the Q1 candidate reference signal resource sets; the first resource set is used to determine the first reference signal resource set from the Q1 candidate reference signal resource sets; Q1 is a positive integer greater than 1, and Q2 is a positive integer greater than 1.

In one embodiment, a technical feature of the above method is that the Q2 cells can be independently configured with QCL relationships associated with a same TCI-StateId, i.e., the same TCI-StateId indicates different reference signal resources for different cells, thus ensuring greater flexibility.

According to one aspect of the present application, comprising:
receiving a second signal in a second resource set;
herein, the target identity being used to determine a second target reference signal resource, the second target reference signal resource being one of the K1 first-type reference signal resources; at least one of the time-domain resource occupied by the first resource set or the frequency-domain resource occupied by the first resource set is used to determine whether the second target reference signal resource is QCL with the first target reference signal resource.

According to one aspect of the present application, comprising:
transmitting a second signal in a second resource set;
herein, the target identity being used to determine a second target reference signal resource, the second target reference signal resource being one of the K1 first-type reference signal resources; at least one of the time-domain resource occupied by the first resource set or the frequency-domain resource occupied by the first resource set is used to determine whether the second target reference signal resource is QCL with the first target reference signal resource.

In one embodiment, a technical feature of the above method is that the above method is targeted for unified TCI scenarios, where when the first signal and the second signal are capable of indication of a unified TCI, the unified TCI is only effective when the first signal and the second signal are in the same duplex mode.

In one embodiment, another technical feature of the above method is that the QCL relationship of the first signal and the QCL relationship of the second signal can be identical and uniformly updated only when the first signal and the second signal both belong to resources supporting full duplex or when they belong to resources not supporting full duplex; when a duplex mode of the resource in which the first signal is present is different from a duplex mode of the resource in which the second signal is present, the QCL relationship of the first signal and the QCL relationship of the second signal cannot be considered identical and cannot be uniformly updated.

According to one aspect of the present application, there exist a first physical channel and a second physical channel respectively in two different cells among the Q2 cells, and a same TCI state ID is used to indicate or update or activate a QCL parameter of the first physical channel or a QCL parameter of the second physical channel; the first physical channel and the second physical channel are both PDCCHs or the first physical channel and the second physical channel are both PDSCHs, or, the first physical channel and the second physical channel are both PUCCHs or the first physical channel and the second physical channel are both PUSCHs.

In one embodiment, a technical feature of the above method is that the above method is targeted for common TCI scenarios, i.e. channels of the same type located on different carriers are allowed to be activated, updated or indicated simultaneously by means of a single TCI-StateId.

In one embodiment, another technical feature of the above method is that the QCL relationship of the first signal and the QCL relationship of the second signal can be identical and uniformly updated only when the first signal and the second signal both belong to resources supporting full duplex or when they belong to resources not supporting full duplex; when a duplex mode of the resource in which the first signal is present is different from a duplex mode of the resource in which the second signal is present, the QCL relationship of the first signal and the QCL relationship of the second signal cannot be considered identical and cannot be uniformly updated.

According to one aspect of the present application, comprising:
receiving a second information block, the second information block indicating that the first signal and the second signal use a same TCI state.

According to one aspect of the present application, K1 is equal to 2, the K1 first-type reference signal resources including a first reference signal resource and a second reference signal resource; the time-domain resource occupied by the first resource set comprises a first symbol set; when a slot format used by a symbol in the first symbol set is a first format, the first target reference signal resource is the first reference signal resource; when a slot format used by a symbol in the first symbol set is a format other than the first format, the first target reference signal resource is the second reference signal resource.

In one embodiment, a technical feature of the above method is that when whether full duplex is supported is differentiated by time-domain resources, the time-domain resources in which the first resource set is located will be used to determine a reference signal resource that actually corresponds to a TCI-StateId indicated by the first information block.

According to one aspect of the present application, K1 is equal to 2, the K1 first-type reference signal resources including a first reference signal resource and a second reference signal resource; when the frequency-domain resource occupied by the first resource set belongs to a first frequency-domain resource set, the first target reference signal resource is the first reference signal resource; when the first resource set comprises a frequency-domain resource not belonging to the first frequency-domain resource set, the first target reference signal resource is the second reference signal resource.

In one embodiment, a technical feature of the above method is that when whether full duplex is supported is differentiated by frequency-domain resources, the frequency-domain resources in which the first resource set is located will be used to determine a reference signal resource that actually corresponds to a TCI-StateId indicated by the first information block.

According to one aspect of the present application, K1 is equal to 2, the K1 first-type reference signal resources including a first reference signal resource and a second reference signal resource; when a time-frequency resource occupied by the first resource set belongs to a first time-frequency resource set, the first target reference signal resource is the first reference signal resource; when the first resource set comprises a time-frequency resource not belonging to the first time-frequency resource set, the first target reference signal resource is the second reference signal resource.

According to one aspect of the present application, comprising:
receiving a third information block, the third information block indicating M1 candidate reference signal resource pools;
herein, the M1 candidate reference signal resource pools respectively corresponding to M1 first-type identities, the target identity being one of the M1 first-type identities; the target identity is used to determine a target candidate reference signal resource pool from the M1 candidate reference signal resource pools, the target candidate reference signal resource pool comprising the Q1 candidate reference signal resource sets; M1 is a positive integer greater than 1.

In one embodiment, a technical feature of the above method is that the M1 first-type identities correspond to M1 TCI-StateIds respectively; in a serving cell, each TCI-StateId is associated with a candidate reference signal resource set in a candidate reference signal resource pool, and subsequently, based on the resources where the actual scheduling is located, it is determined which candidate reference signal in the candidate reference signal resource set will be used as the actually employed QCL relationship.

The present application provides a method in a second node for wireless communications, comprising:
transmitting a first information block, the first information block indicating a target identity; and
transmitting a first signal in a first resource set, with a demodulation reference signal (DMRS) of a channel occupied by the first signal being quasi co-located with a first target reference signal resource;
herein, the target identity is associated with K1 first-type reference signal resources, and the K1 first-type reference signal resources are associated with a first cell, K1 being a positive integer greater than 1; the first target reference signal resource is one of the K1 first-type reference signal resources; a frequency-domain resource occupied by the first resource set belongs to the first cell; at least one of a time-domain resource occupied by the first resource set or the frequency-domain resource occupied by the first resource set is used to determine the first target reference signal resource from the K1 first-type reference signal resources.

The present application provides a method in a second node for wireless communications, comprising:
transmitting a first information block, the first information block indicating a target identity; and
receiving a first signal in a first resource set, with a demodulation reference signal (DMRS) of a channel occupied by the first signal being quasi co-located with a first target reference signal resource;
herein, the target identity is associated with K1 first-type reference signal resources, and the K1 first-type reference signal resources are associated with a first cell, K1 being a positive integer greater than 1; the first target reference signal resource is one of the K1 first-type reference signal resources; a frequency-domain resource occupied by the first resource set belongs to the first cell; at least one of a time-domain resource occupied by the first resource set or the frequency-domain resource occupied by the first resource set is used to determine the first target reference signal resource from the K1 first-type reference signal resources.

According to one aspect of the present application, the target identity is associated with any candidate reference signal resource set of Q1 candidate reference signal resource sets, the Q1 candidate reference signal resource sets being associated with Q2 cells; a first reference signal resource set comprises the K1 first-type reference signal resources; the first reference signal resource set is one of the Q1 candidate reference signal resource sets; the first resource set is used to determine the first reference signal resource set from the Q1 candidate reference signal resource sets; Q1 is a positive integer greater than 1, and Q2 is a positive integer greater than 1.

According to one aspect of the present application, comprising:
transmitting a second signal in a second resource set;
herein, the target identity is used to determine a second target reference signal resource, the second target reference signal resource being one of the K1 first-type reference signal resources; at least one of the time-domain resource occupied by the first resource set or the frequency-domain resource occupied by the first resource set is used to determine whether the second target reference signal resource is QCL with the first target reference signal resource.

According to one aspect of the present application, comprising:
receiving a second signal in a second resource set;
herein, the target identity is used to determine a second target reference signal resource, the second target reference signal resource being one of the K1 first-type reference signal resources; at least one of the time-domain resource occupied by the first resource set or the frequency-domain resource occupied by the first resource set is used to determine whether the second target reference signal resource is QCL with the first target reference signal resource.

According to one aspect of the present application, there exist a first physical channel and a second physical channel respectively in two different cells among the Q2 cells, and a same TCI state ID is used to indicate or update or activate a QCL parameter of the first physical channel or a QCL parameter of the second physical channel; the first physical channel and the second physical channel are both PDCCHs or the first physical channel and the second physical channel are both PDSCHs, or, the first physical channel and the second physical channel are both PUCCHs or the first physical channel and the second physical channel are both PUSCHs.

According to one aspect of the present application, comprising:
transmitting a second information block;
herein, the second information block indicates that the first signal and the second signal use a same TCI state.

According to one aspect of the present application, K1 is equal to 2, the K1 first-type reference signal resources including a first reference signal resource and a second reference signal resource; the time-domain resource occupied by the first resource set comprises a first symbol set; when a slot format used by a symbol in the first symbol set is a first format, the first target reference signal resource is the first reference signal resource; when a slot format used by a symbol in the first symbol set is a format other than the first format, the first target reference signal resource is the second reference signal resource.

According to one aspect of the present application, K1 is equal to 2, the K1 first-type reference signal resources including a first reference signal resource and a second reference signal resource; when the frequency-domain resource occupied by the first resource set belongs to a first frequency-domain resource set, the first target reference signal resource is the first reference signal resource; when the first resource set comprises a frequency-domain resource not belonging to the first frequency-domain resource set, the first target reference signal resource is the second reference signal resource.

According to one aspect of the present application, comprising:
transmitting a third information block;
herein, the third information block indicates M1 candidate reference signal resource pools, the M1 candidate reference signal resource pools respectively corresponding to M1 first-type identities, the target identity being one of the M1 first-type identities; the target identity is used to determine a target candidate reference signal resource pool from the M1 candidate reference signal resource pools, the target candidate reference signal resource pool comprising the Q1 candidate reference signal resource sets; M1 is a positive integer greater than 1.

The present application provides a first node for wireless communications, comprising:
a first receiver, receiving a first information block, the first information block indicating a target identity; and
a first transceiver, receiving a first signal in a first resource set, with a demodulation reference signal (DMRS) of a channel occupied by the first signal being quasi co-located with a first target reference signal resource;
herein, the target identity is associated with K1 first-type reference signal resources, and the K1 first-type reference signal resources are associated with a first cell, K1 being a positive integer greater than 1; the first target reference signal resource is one of the K1 first-type reference signal resources; a frequency-domain resource occupied by the first resource set belongs to the first cell; at least one of a time-domain resource occupied by the first resource set or the frequency-domain resource occupied by the first resource set is used to determine the first target reference signal resource from the K1 first-type reference signal resources.

The present application provides a first node for wireless communications, comprising:
a first receiver, receiving a first information block, the first information block indicating a target identity; and
a first transceiver, transmitting a first signal in a first resource set, with a demodulation reference signal (DMRS) of a channel occupied by the first signal being quasi co-located with a first target reference signal resource;
herein, the target identity is associated with K1 first-type reference signal resources, and the K1 first-type reference signal resources are associated with a first cell, K1 being a positive integer greater than 1; the first target reference signal resource is one of the K1 first-type reference signal resources; a frequency-domain resource occupied by the first resource set belongs to the first cell; at least one of a time-domain resource occupied by the first resource set or the frequency-domain resource occupied by the first resource set is used to determine the first target reference signal resource from the K1 first-type reference signal resources.

The present application provides a second node for wireless communications, comprising:
a first transmitter, transmitting a first information block, the first information block indicating a target identity; and
a second transceiver, transmitting a first signal in a first resource set, with a demodulation reference signal (DMRS) of a channel occupied by the first signal being quasi co-located with a first target reference signal resource;
herein, the target identity is associated with K1 first-type reference signal resources, and the K1 first-type reference signal resources are associated with a first cell, K1 being a positive integer greater than 1; the first target reference signal resource is one of the K1 first-type reference signal resources; a frequency-domain resource occupied by the first resource set belongs to the first cell; at least one of a time-domain resource occupied by the first resource set or the frequency-domain resource occupied by the first resource set is used to determine the first target reference signal resource from the K1 first-type reference signal resources.

The present application provides a second node for wireless communications, comprising:
a first transmitter, transmitting a first information block, the first information block indicating a target identity; and
a second transceiver, receiving a first signal in a first resource set, with a demodulation reference signal (DMRS) of a channel occupied by the first signal being quasi co-located with a first target reference signal resource;
herein, the target identity is associated with K1 first-type reference signal resources, and the K1 first-type reference signal resources are associated with a first cell, K1 being a positive integer greater than 1; the first target reference signal resource is one of the K1 first-type reference signal resources; a frequency-domain resource occupied by the first resource set belongs to the first cell; at least one of a time-domain resource occupied by the first resource set or the frequency-domain resource occupied by the first resource set is used to determine the first target reference signal resource from the K1 first-type reference signal resources.

In one embodiment, compared with the prior art, the present application is advantageous in the following aspects:
the K1 first-type reference signals correspond to K1 QCL relationships that can be indicated by a TCI-StateId associated to a carrier, and the K1 QCL relationships are used for different interference situations, respectively. For example, when the first signal is located in resources supporting full duplex, the target identity indicates one of the K1 QCL relationships to avoid particular interference situations that may arise in a full-duplex scenario; when the first signal is located outside of the resources supporting full duplex, the target identity indicates another one of the K1 QCL relationships to maximize the system performance;
the Q2 cells can be independently configured with QCL relationships associated with a same TCI-StateId, i.e., the same TCI-StateId indicates different reference signal resources for different cells, thus ensuring greater flexibility;
the QCL relationship of the first signal and the QCL relationship of the second signal can be identical and uniformly updated only when the first signal and the second signal both belong to resources supporting full duplex or when they belong to resources not supporting full duplex; when a duplex mode of the resource in which the first signal is present is different from a duplex mode of the resource in which the second signal is present, the QCL relationship of the first signal and the QCL relationship of the second signal cannot be considered identical and cannot be uniformly updated;
the M1 first-type identities correspond to M1 TCI-StateIds respectively; in a serving cell, each TCI-StateId is associated with a candidate reference signal resource set in a candidate reference signal resource pool, and subsequently, based on the resources where the actual scheduling is located, it is determined which candidate reference signal in the candidate reference signal resource set will be used as the actually employed QCL relationship.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of processing of a first node according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of a first information block according to one embodiment of the present application.

FIG. 6 illustrates a flowchart of a first information block according to another embodiment of the present application.

FIG. 7 illustrates a flowchart of a second signal according to one embodiment of the present application.

FIG. 8 illustrates a flowchart of a second signal according to another embodiment of the present application.

FIG. 9 illustrates a flowchart of a second information block according to one embodiment of the present application.

FIG. 10 illustrates a flowchart of a third information block according to one embodiment of the present application.

FIG. 11 illustrates a schematic diagram of K1 first-type reference signal resources according to one embodiment of the present application.

FIG. 12 illustrates a schematic diagram of Q1 candidate reference signal resource sets according to one embodiment of the present application.

FIG. 13 illustrates a schematic diagram of a first signal and a second signal according to one embodiment of the present application.

FIG. 14 illustrates a schematic diagram of M1 candidate reference signal resource pools according to one embodiment of the present application.

FIG. 15 illustrates a schematic diagram of an application scenario according to one embodiment of the present application.

FIG. 16 illustrates a structure block diagram of a processing device in a first node according to one embodiment of the present application.

FIG. 17 illustrates a structure block diagram of a processing device in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

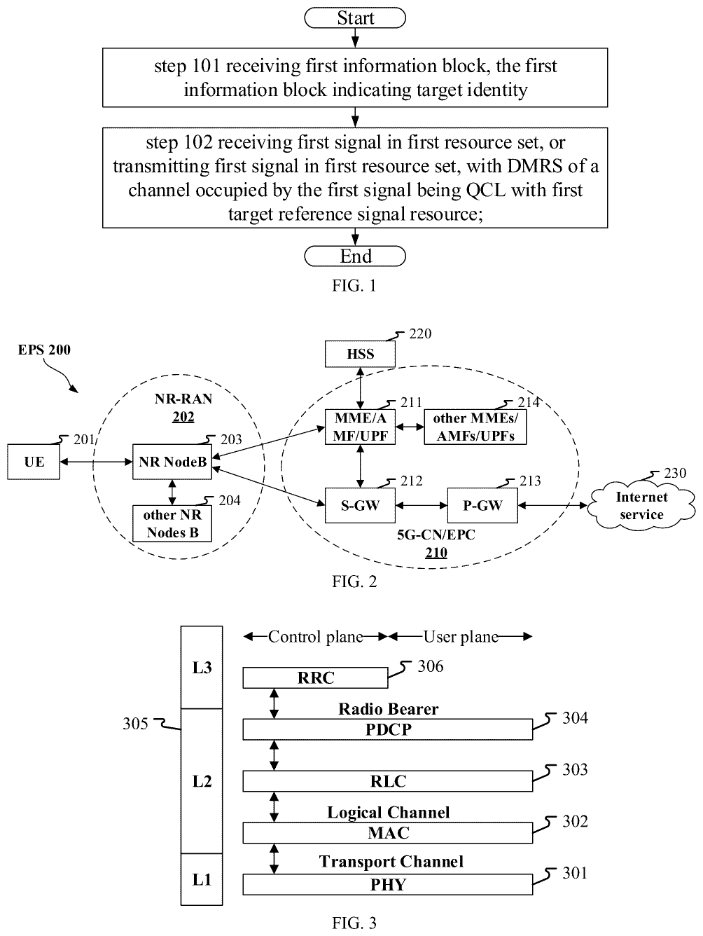

Embodiment 1 illustrates a flowchart of processing of a first node, as shown in FIG. 1. In 100 illustrated by FIG. 1, each box represents a step. In Embodiment 1, the first node in this application receives a first information block in step 101, the first information block indicating a target identity; and in step 102, receives a first signal in a first resource set, or transmits a first signal in a first resource set, with a demodulation reference signal (DMRS) of a channel occupied by the first signal being quasi co-located with a first target reference signal resource.

In Embodiment 1, the target identity is associated with K1 first-type reference signal resources, and the K1 first-type reference signal resources are associated with a first cell, K1 being a positive integer greater than 1; the first target reference signal resource is one of the K1 first-type reference signal resources; a frequency-domain resource occupied by the first resource set belongs to the first cell; at least one of a time-domain resource occupied by the first resource set or the frequency-domain resource occupied by the first resource set is used to determine the first target reference signal resource from the K1 first-type reference signal resources.

In one embodiment, the first information block is transmitted via a Radio Resource Control (RRC) signaling.

In one embodiment, the first information block is transmitted through a Physical Downlink Control Channel (PDCCH).

In one embodiment, the first information block is transmitted via Downlink Control Information (DCI).

In one embodiment, the first information block is transmitted via Medium Access Control (MAC) Control Elements (CE).

In one embodiment, the first information block is a field in a DCI.

In one embodiment, the first information block is a TCI field in a DCI.

In one embodiment, the target identity is a non-negative integer.

In one embodiment, the target identity identifies a TCI state.

In one embodiment, the target identity is a TCI state index.

In one embodiment, the target identity is a TCI state ID.

In one embodiment, the target identity is a TCI-StateId.

In one embodiment, the target identity is a Channel State Information Reference Signal Resource Indicator (CRI).

In one embodiment, the target identity is a Sounding Reference Signal Resource Indicator (SRI).

In one embodiment, the target identity is a Reference Signal Resource Index.

In one embodiment, the first resource set comprises at least one of a time-domain resource, a frequency-domain resource or a code-domain resource.

In one embodiment, the first resource set comprises spatial domain resource(s).

In one embodiment, the first resource set occupies a positive integer number of REs.

In one embodiment, the first resource set occupies a positive integer number of subcarriers in frequency domain, and the first resource set occupies time-domain resource(s) corresponding to at least one Orthogonal Frequency Division Multiplexing (OFDM) symbol in time domain.

In one embodiment, the first resource set occupies at least one code-domain resource.

In one embodiment, the first resource set occupies at least one multiple access signature.

In one embodiment, the first signal is a radio signal.

In one embodiment, the first signal is a baseband signal.

In one embodiment, a physical layer channel occupied by the first signal includes a Physical Downlink Shared Channel (PDSCH).

In one embodiment, a physical layer channel occupied by the first signal includes a Physical Uplink Shared Channel (PUSCH).

In one embodiment, a transport channel occupied by the first signal includes a Downlink Shared Channel (DL-SCH).

In one embodiment, a transport channel occupied by the first signal includes an Uplink Shared Channel (UL-SCH).

In one embodiment, a physical layer channel occupied by the first signal includes a Physical Downlink Control Channel (PDCCH).

In one embodiment, a physical layer channel occupied by the first signal includes a Physical Uplink Control Channel (PUCCH).

In one embodiment, the meaning of the phrase a demodulation reference signal (DMRS) of a channel occupied by the first signal being quasi co-located with a first target reference signal resource includes: the first signal is QCL with the reference signal transmitted in the first target reference signal resource.

In one embodiment, the meaning of the phrase a demodulation reference signal (DMRS) of a channel occupied by the first signal being quasi co-located with a first target reference signal resource includes: a DMRS for demodulating the first signal is QCL with the reference signal transmitted in the first target reference signal resource.

In one embodiment, two signals being QCL means: the large-scale properties of a channel over which one of the two signals is conveyed can be inferred from the large-scale properties of a channel over which the other of the two signals is conveyed.

In one embodiment, the large-scale properties include one or more of a delay spread, a Doppler spread, a Doppler shift, an average delay or a Spatial Rx parameter.

In one embodiment, the first node assumes that a reference signal transmitted in the first target reference signal resource is quasi co-located with the first signal.

In one embodiment, the first node may assume that a reference signal transmitted in the first target reference signal resource is quasi co-located with the first signal.

In one embodiment, a transmitter of a reference signal transmitted in the first target reference signal resource assumes that the reference signal transmitted in the first target reference signal resource is quasi co-located with the first signal.

In one embodiment, the first node uses a same spatial domain filter to receive the reference signal transmitted in the first target reference signal resource and the first signal.

In one embodiment, a transmitter of a reference signal transmitted in the first target reference signal resource assumes that the first node uses a same spatial domain filter to receive the reference signal transmitted in the first target reference signal resource and the first signal.

In one embodiment, the first node may infer a spatial reception (Rx) parameter of the first signal from a spatial Rx parameter of a reference signal transmitted in the first target reference signal resource.

In one embodiment, the first node may infer a spatial transmit (Tx) parameter of the first signal from a spatial Rx parameter of a reference signal transmitted in the first target reference signal resource.

In one embodiment, the first target reference signal resource comprises a Channel-State Information Reference Signal (CSI-RS) resource.

In one embodiment, the first target reference signal resource comprises a SS/PBCH Block (SSB).

In one embodiment, the first target reference signal resource comprises a Demodulation Reference Signal (DMRS) resource.

In one embodiment, the first target reference signal resource comprises a Sounding Reference Signal (SRS) resource.

In one embodiment, the first target reference signal resource corresponds to a TCI.

In one embodiment, the first target reference signal resource corresponds to a TCI-State.

In one embodiment, the first target reference signal resource corresponds to a TCI-StateId.

In one embodiment, the first target reference signal resource corresponds to an SRI.

In one embodiment, the first target reference signal resource corresponds to a CRI.

In one embodiment, at least one of the K1 first-type reference signal resources comprises a CSI-RS resource.

In one embodiment, at least one of the K1 first-type reference signal resources comprises an SSB.

In one embodiment, at least one of the K1 first-type reference signal resources comprises a DMRS resource.

In one embodiment, at least one of the K1 first-type reference signal resources comprises a SRS resource.

In one embodiment, at least one of the K1 first-type reference signal resources corresponds to a TCI.

In one embodiment, at least one of the K1 first-type reference signal resources corresponds to a TCI-State.

In one embodiment, at least one of the K1 first-type reference signal resources corresponds to a TCI-StateId.

In one embodiment, any one of the K1 first-type reference signal resources corresponds to a TCI-State.

In one embodiment, any one of the K1 first-type reference signal resources corresponds to a TCI-StateId.

In one embodiment, at least one of the K1 first-type reference signal resources corresponds to an SRI.

In one embodiment, at least one of the K1 first-type reference signal resources corresponds to a CRI.

In one embodiment, the above sentence that the target identity is associated with K1 first-type reference signal resources means that the target identity is used to indicate a first-type reference signal resource of the K1 first-type reference signal resources.

In one embodiment, the above sentence that the target identity is associated with K1 first-type reference signal resources means that the target identity is used to indicate at least one first-type reference signal resource of the K1 first-type reference signal resources.

In one embodiment, the above sentence that the target identity is associated with K1 first-type reference signal resources means that the target identity is used to indicate at least two first-type reference signal resources of the K1 first-type reference signal resources.

In one embodiment, K1 is equal to 2.

In one embodiment, the first cell is a Serving Cell.

In one embodiment, the first cell corresponds to a Carrier.

In one embodiment, the first cell corresponds to a Physical Cell Identity (PCI).

In one embodiment, the first cell corresponds to a ServCellIndex.

In one embodiment, the first cell corresponds to a ServCellId.

In one embodiment, the first cell corresponds to a ServCellIdentity.

In one embodiment, the first cell is a serving cell of the first node.

In one embodiment, the sentence that “the K1 first-type reference signal resources are associated with a first cell” means that at least one first-type reference signal resource of the K1 first-type reference signal resources is used to determine a QCL parameter of a channel transmitted on the first cell.

In one embodiment, the sentence that “the K1 first-type reference signal resources are associated with a first cell” means that any first-type reference signal resource of the K1 first-type reference signal resources is used to determine a QCL parameter of a signal transmitted in the first cell.

In one embodiment, the sentence that “the K1 first-type reference signal resources are associated with a first cell” means that the K1 first-type reference signal resources are used to determine a QCL parameter of a signal transmitted in the first cell.

In one embodiment, the sentence that “the K1 first-type reference signal resources are associated with a first cell” means that the K1 first-type reference signal resources are used to determine a QCL parameter of a PDSCH or a PDCCH on the first cell.

In one embodiment, the sentence that “the K1 first-type reference signal resources are associated with a first cell” means that the K1 first-type reference signal resources are configured for the first cell.

In one embodiment, the sentence that “the K1 first-type reference signal resources are associated with a first cell” means that an RRC signaling configuring the K1 first-type reference signal resources is further used to indicate an Identity or Index corresponding to the first cell.

In one embodiment, the sentence that “the K1 first-type reference signal resources are associated with a first cell” means that an RRC signaling configuring the K1 first-type reference signal resources is further used to indicate an Identity or Index of a Bandwidth Part (BWP) included by the first cell.

In one embodiment, the type of quasi co-location in the present application includes QCL Type A.

In one embodiment, the type of quasi co-location in the present application includes QCL Type B.

In one embodiment, the type of quasi co-location in the present application includes QCL Type C.

In one embodiment, the type of quasi co-location in the present application includes QCL Type D.

In one embodiment, a time-domain resource occupied by the first resource set is used to determine the first target reference signal resource from the K1 first-type reference signal resources.

In one embodiment, a frequency-domain resource occupied by the first resource set is used to determine the first target reference signal resource from the K1 first-type reference signal resources.

In one embodiment, a time-frequency resource occupied by the first resource set is used to determine the first target reference signal resource from the K1 first-type reference signal resources.

### Embodiment 2

Embodiment 2 illustrates a schematic diagram of a network architecture, as shown in FIG. 2.

FIG. 2 is a diagram illustrating a network architecture 200 of 5G NR, Long-Term Evolution (LTE) and Long-Term Evolution Advanced (LTE-A) systems. The 5G NR or LTE network architecture 200 may be called an Evolved Packet System (EPS) 200 or other suitable terminology. The EPS 200 may comprise one UE 201, an NR-RAN 202, a Evolved Packet Core (EPC)/5G-Core Network (5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will find it easy to understand that various concepts presented throughout the present application can be extended to networks providing circuit switching services or other cellular networks. The NR-RAN 202 comprises an NR node B (gNB) 203 and other gNBs 204. The gNB 203 provides UE 201 oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212. The S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE201 corresponds to the first node in the present application.

In one embodiment, the UE201 supports Unpaired Spectrum scenarios.

In one embodiment, the UE201 supports Flexible Duplex frequency-domain resource configuration.

In one embodiment, the UE201 supports Full Duplex transmission.

In one embodiment, the UE201 supports dynamic adjustment of uplink and downlink transmission directions.

In one embodiment, the gNB203 corresponds to the second node in the present application.

In one embodiment, the gNB203 supports Unpaired Spectrum scenarios

In one embodiment, the gNB203 supports Flexible Duplex frequency-domain resource configuration.

In one embodiment, the gNB203 supports Full Duplex transmission.

In one embodiment, the gNB203 supports dynamic adjustment of uplink and downlink transmission directions.

### Embodiment 3

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first communication node (UE, gNB or, RSU in V2X) and a second communication node (gNB, UE, or RSU in V2X), is represented by three layers, i.e., layer 1, layer 2 and layer 3. The layer 1 (L1) is the lowest layer which performs signal processing functions of various PHY layers. The L1 is called PHY 301 in the present application. The layer 2 (L2) 305 is above the PHY 301, and is in charge of the link between a first communication node and a second communication node via the PHY 301. The L2 305 comprises a Medium Access Control (MAC) sublayer 302, a Radio Link Control (RLC) sublayer 303 and a Packet Data Convergence Protocol (PDCP) sublayer 304. All these sublayers terminate at the second communication nodes. The PDCP sublayer 304 provides multiplexing among variable radio bearers and logical channels. The PDCP sublayer 304 provides security by encrypting packets and also support for inter-cell handover of the second communication node between first communication nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. In the control plane 300, The Radio Resource Control (RRC) sublayer 306 in the L3 is responsible for acquiring radio resources (i.e., radio bearer) and configuring the lower layer using an RRC signaling between the second communication node and the first communication node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first communication node may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the PDCP304 of the second communication node is used for generating scheduling of the first communication node.

In one embodiment, the PDCP354 of the second communication node is used for generating scheduling of the first communication node.

In one embodiment, the first information block is generated by the PHY 301, or the PHY 351.

In one embodiment, the first information block is generated by the MAC302 or the MAC352.

In one embodiment, the first information block is generated by the RRC 306.

In one embodiment, the first signal is generated by the PHY 301 or the PHY 351.

In one embodiment, the first signal is generated by the MAC302 or the MAC352.

In one embodiment, the first signal is generated by the RRC 306.

In one embodiment, the second signal is generated by the PHY 301, or the PHY 351.

In one embodiment, the second signal is generated by the MAC302 or the MAC352.

In one embodiment, the second signal is generated by the RRC 306.

In one embodiment, the second information block is generated by the MAC302 or the MAC352.

In one embodiment, the second information block is generated by the RRC 306.

In one embodiment, the third information block is generated by the MAC302 or the MAC352.

In one embodiment, the third information block is generated by the RRC 306.

In one embodiment, the first node is a terminal.

In one embodiment, the second node is a terminal.

In one embodiment, the second node is a Transmitter Receiver Point (TRP).

In one embodiment, the second node is a cell.

In one embodiment, the second node is an eNB.

In one embodiment, the second node is a base station.

In one embodiment, the second node is used for managing multiple TRPs.

In one embodiment, the second node is used for managing multiple nodes of cells.

In one embodiment, the second node is used for managing multiple nodes of carriers.

### Embodiment 4

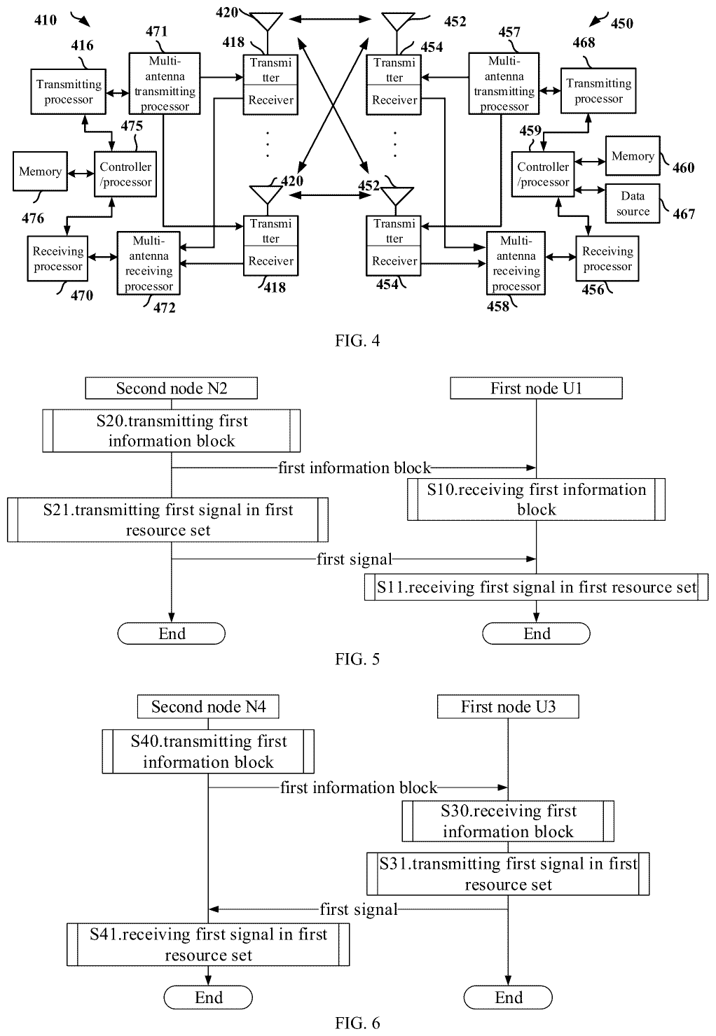

Embodiment 4 illustrates a schematic diagram of a first communication device and a second communication device according to the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer. In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, where the reference signal is used for channel estimation, while the data signal is subjected to multi-antenna detection in the multi-antenna receiving processor 458 to recover any first communication device 450-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with the memory 460 that stores program code and data. the memory 460 may be called a computer readable medium. In the transmission from the second communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data; the memory 476 may be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication device 450 comprises at least one processor and at least one memory. The at least one memory comprises computer program codes; the at least one memory and the computer program codes are configured to be used in collaboration with the at least one processor. The first communication device 450 at least firstly receives a first information block, the first information block indicating a target identity; and then receives a first signal in a first resource set, or transmits a first signal in a first resource set, with a demodulation reference signal (DMRS) of a channel occupied by the first signal being QCL with a first target reference signal resource; the target identity is associated with K1 first-type reference signal resources, and the K1 first-type reference signal resources are associated with a first cell, K1 being a positive integer greater than 1; the first target reference signal resource is one of the K1 first-type reference signal resources; a frequency-domain resource occupied by the first resource set belongs to the first cell; at least one of a time-domain resource occupied by the first resource set or the frequency-domain resource occupied by the first resource set is used to determine the first target reference signal resource from the K1 first-type reference signal resources.

In one embodiment, the first communication device 450 comprises a memory that stores a computer readable instruction program. The computer readable instruction program generates actions when executed by at least one processor. The actions include: firstly receiving a first information block, the first information block indicating a target identity; and then receiving a first signal in a first resource set, or transmitting a first signal in a first resource set, with a demodulation reference signal (DMRS) of a channel occupied by the first signal being QCL with a first target reference signal resource; the target identity is associated with K1 first-type reference signal resources, and the K1 first-type reference signal resources are associated with a first cell, K1 being a positive integer greater than 1; the first target reference signal resource is one of the K1 first-type reference signal resources; a frequency-domain resource occupied by the first resource set belongs to the first cell; at least one of a time-domain resource occupied by the first resource set or the frequency-domain resource occupied by the first resource set is used to determine the first target reference signal resource from the K1 first-type reference signal resources.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: firstly transmits a first information block, the first information block indicating a target identity; and then transmits a first signal in a first resource set, or receives a first signal in a first resource set, with a demodulation reference signal (DMRS) of a channel occupied by the first signal being QCL with a first target reference signal resource; the target identity is associated with K1 first-type reference signal resources, and the K1 first-type reference signal resources are associated with a first cell, K1 being a positive integer greater than 1; the first target reference signal resource is one of the K1 first-type reference signal resources; a frequency-domain resource occupied by the first resource set belongs to the first cell; at least one of a time-domain resource occupied by the first resource set or the frequency-domain resource occupied by the first resource set is used to determine the first target reference signal resource from the K1 first-type reference signal resources.

In one embodiment, the second communication device 410 comprises a memory that stores a computer readable instruction program. The computer readable instruction program generates actions when executed by at least one processor. The actions include: firstly transmitting a first information block, the first information block indicating a target identity; and then transmitting a first signal in a first resource set, or receiving a first signal in a first resource set, with a demodulation reference signal (DMRS) of a channel occupied by the first signal being QCL with a first target reference signal resource; the target identity is associated with K1 first-type reference signal resources, and the K1 first-type reference signal resources are associated with a first cell, K1 being a positive integer greater than 1; the first target reference signal resource is one of the K1 first-type reference signal resources; a frequency-domain resource occupied by the first resource set belongs to the first cell; at least one of a time-domain resource occupied by the first resource set or the frequency-domain resource occupied by the first resource set is used to determine the first target reference signal resource from the K1 first-type reference signal resources.

In one embodiment, the first communication device 450 corresponds to the first node in the present application.

In one embodiment, the second communication device 410 corresponds to the second node in the present application.

In one embodiment, the first communication device 450 is a UE.

In one embodiment, the first communication device 450 is a terminal.

In one embodiment, the second communication device 410 is a base station.

In one embodiment, the second communication device 410 is a UE.

In one embodiment, the second communication device 410 is network equipment.

In one embodiment, the second communication device 410 is a serving cell.

In one embodiment, the second communication device 410 is a TRP.

In one embodiment, at least the first four of the antenna 452, the receiver 454, the multi-antenna receiving processor 458, the receiving processor 456, and the controller/processor 459 are used for receiving a first information block; at least the first four of the antenna 420, the transmitter 418, the multi-antenna transmitting processor 471, the transmitting processor 416 and the controller/processor 475 are used for transmitting a first information block.

In one embodiment, at least the first four of the antenna 452, the receiver 454, the multi-antenna receiving processor 458, the receiving processor 456, and the controller/processor 459 are used for receiving a first signal in a first resource set; at least the first four of the antenna 420, the transmitter 418, the multi-antenna transmitting processor 471, the transmitting processor 416 and the controller/processor 475 are used for transmitting a first signal in a first resource set.

In one embodiment, at least the first four of the antenna 452, the transmitter 454, the multi-antenna transmitting processor 457, the transmitting processor 468, and the controller/processor 459 are used for transmitting a first signal in a first resource set; at least the first four of the antenna 420, the receiver 418, the multi-antenna receiving processor 472, the receiving processor 470 and the controller/processor 475 are used for receiving a first signal in a first resource set.

In one embodiment, at least the first four of the antenna 452, the receiver 454, the multi-antenna receiving processor 458, the receiving processor 456, and the controller/processor 459 are used for receiving a second signal in a second resource set; at least the first four of the antenna 420, the transmitter 418, the multi-antenna transmitting processor 471, the transmitting processor 416 and the controller/processor 475 are used for transmitting a second signal in a second resource set.

In one embodiment, at least the first four of the antenna 452, the transmitter 454, the multi-antenna transmitting processor 457, the transmitting processor 468, and the controller/processor 459 are used for transmitting a second signal in a second resource set; at least the first four of the antenna 420, the receiver 418, the multi-antenna receiving processor 472, the receiving processor 470 and the controller/processor 475 are used for receiving a second signal in a second resource set.

In one embodiment, at least the first four of the antenna 452, the receiver 454, the multi-antenna receiving processor 458, the receiving processor 456, and the controller/processor 459 are used for receiving a second information block; at least the first four of the antenna 420, the transmitter 418, the multi-antenna transmitting processor 471, the transmitting processor 416 and the controller/processor 475 are used for transmitting a second information block.

In one embodiment, at least the first four of the antenna 452, the receiver 454, the multi-antenna receiving processor 458, the receiving processor 456, and the controller/processor 459 are used for receiving a third information block; at least the first four of the antenna 420, the transmitter 418, the multi-antenna transmitting processor 471, the transmitting processor 416 and the controller/processor 475 are used for transmitting a third information block.

### Embodiment 5

Embodiment 5 illustrates a flowchart of a first information block, as shown in FIG. 5. In FIG. 5, a first node U1 and a second node N2 are in communication via a radio link. It should be particularly noted that the sequence illustrated herein does not set any limit to the signal transmission order or implementation order in the present application. In case of no conflict, the embodiments, sub-embodiments, and subsidiary embodiments in Embodiment 5 can be applied to Embodiments 6, 7, 8, 9 or 10; conversely, in case of no conflict, the embodiments, sub-embodiments, and subsidiary embodiments in Embodiments 6, 7, 8, 9 or 10 can be applied to Embodiment 5.

The first node U1 receives a first information block in step S10; and receives a first signal in a first resource set in step S11.

The second node N2 transmits a first information block in step S20; and transmits a first signal in a first resource set in step S21.

In Embodiment 5, the first information block indicates a target identity; a demodulation reference signal (DMRS) of a channel occupied by the first signal is quasi co-located with a first target reference signal resource; the target identity is associated with K1 first-type reference signal resources, and the K1 first-type reference signal resources are associated with a first cell, K1 being a positive integer greater than 1; the first target reference signal resource is one of the K1 first-type reference signal resources; a frequency-domain resource occupied by the first resource set belongs to the first cell; at least one of a time-domain resource occupied by the first resource set or the frequency-domain resource occupied by the first resource set is used to determine the first target reference signal resource from the K1 first-type reference signal resources.

In one embodiment, the target identity is associated with any candidate reference signal resource set of Q1 candidate reference signal resource sets, the Q1 candidate reference signal resource sets being associated with Q2 cells; a first reference signal resource set comprises the K1 first-type reference signal resources; the first reference signal resource set is one of the Q1 candidate reference signal resource sets; the first resource set is used to determine the first reference signal resource set from the Q1 candidate reference signal resource sets; Q1 is a positive integer greater than 1, and Q2 is a positive integer greater than 1.

In one subembodiment, the Q2 cells include the first cell, the first resource set occupying a frequency-domain resource belonging to the frequency-domain resources corresponding to the first cell.

In one subsidiary embodiment of this subembodiment, the first cell is used to determine the first reference signal resource set from the Q1 candidate reference signal resource sets.

In one subembodiment, Q2 is equal to Q1, and the Q1 candidate reference signal resource sets are respectively associated with the Q2 cells.

In one subembodiment, Q2 is greater than Q1, and at least one of the Q1 candidate reference signal resource sets is associated with at least two of the Q2 cells.

In one subsidiary embodiment of the above two subembodiments, a given candidate reference signal resource set is any one of the Q1 candidate reference signal resource sets, the given candidate reference signal resource set is associated with a given cell among the Q2 cells, and the given candidate reference signal resource set is used to determine a QCL parameter for a signal transmitted in the given cell.

In one subembodiment, the Q2 cells are Q2 serving cells, respectively.

In one subembodiment, the Q2 cells correspond to Q2 carriers, respectively.

In one subembodiment, the Q2 cells correspond to Q2 PCIs, respectively.

In one subembodiment, the Q2 cells correspond to Q2 ServCellIndexes, respectively.

In one subembodiment, the Q2 cells correspond to Q2 ServCellIds, respectively.

In one subembodiment, the Q2 cells correspond to Q2 ServCellIdentitys, respectively.

In one subembodiment, any one of the Q1 candidate reference signal resource sets comprises a plurality of candidate reference signal resources, and any of the plurality of candidate reference signal resources comprises at least one of a CSI-RS resource or an SSB.

In one subembodiment, any one of the Q1 candidate reference signal resource sets comprises a plurality of candidate reference signal resources, and any of the plurality of candidate reference signal resources comprises a DMRS resource or an SRS resource.

In one subembodiment, the meaning of the phrase that the first resource set is used to determine the first reference signal resource set from the Q1 candidate reference signal resource sets comprises: a frequency-domain resource occupied by the first resource set is used to determine the first reference signal resource set from the Q1 candidate reference signal resource sets.

In one subembodiment, the meaning of the phrase that the first resource set is used to determine the first reference signal resource set from the Q1 candidate reference signal resource sets comprises: the first cell in which the first resource set is located is used to determine the first reference signal resource set from the Q1 candidate reference signal resource sets.

In one subembodiment, the meaning of the phrase that the first resource set is used to determine the first reference signal resource set from the Q1 candidate reference signal resource sets comprises: the first reference signal resource set is configured to be associated with a frequency-domain resource occupied by the first resource set.

In one subembodiment, the meaning of the phrase that the first resource set is used to determine the first reference signal resource set from the Q1 candidate reference signal resource sets comprises: the first reference signal resource set is configured to be associated with the first cell in which the first resource set is located.

In one embodiment, there exist a first physical channel and a second physical channel respectively in two different cells among the Q2 cells in this application, and a same TCI state ID is used to indicate or update or activate a QCL parameter of the first physical channel or a QCL parameter of the second physical channel; the first physical channel and the second physical channel are both PDCCHs or the first physical channel and the second physical channel are both PDSCHs, or, the first physical channel and the second physical channel are both PUCCHs or the first physical channel and the second physical channel are both PUSCHs.

In one subembodiment, the meaning of two different cells as described above includes that the two different cells each occupy different frequency-domain resources.

In one subembodiment, the meaning of two different cells as described above includes that the two different cells respectively correspond to two different PCIs.

In one subembodiment, the meaning of two different cells as described above includes that the two different cells respectively correspond to two different ServCellIndexes.

In one subembodiment, the meaning of two different cells as described above includes that the two different cells respectively correspond to two different ServCellIds.

In one subembodiment, the meaning of two different cells as described above includes that the two different cells respectively correspond to two different ServCellIdentitys.

In one subembodiment, a frequency-domain resource occupied by the first physical channel belongs to the frequency-domain resources corresponding to one of the two different cells, and a frequency-domain resource occupied by the second physical channel belongs to the frequency-domain resources corresponding to the other of the two different cells.

In one subembodiment, the QCL parameter comprises a reference signal resource of QCL.

In one subembodiment, the QCL parameter comprises a TCI state corresponding to a reference signal resource of QCL.

In one subembodiment, the QCL parameter comprises a TCI state ID corresponding to a reference signal resource of QCL.

In one subembodiment, the QCL parameter comprises spatial reception (Rx) parameter.

In one subembodiment, the QCL parameters comprise spatial transmit (Tx) parameter.

In one embodiment, K1 is equal to 2, the K1 first-type reference signal resources including a first reference signal resource and a second reference signal resource; the time-domain resource occupied by the first resource set comprises a first symbol set; when a slot format used by a symbol in the first symbol set is a first format, the first target reference signal resource is the first reference signal resource; when a slot format used by a symbol in the first symbol set is a format other than the first format, the first target reference signal resource is the second reference signal resource.

In one subembodiment, the first symbol set comprises at least one OFDM symbol in time domain.

In one subembodiment, the first format is “F”.

In one subembodiment, the formats other than the first format include a second format and a third format.

In one subsidiary embodiment of the above subembodiment, the second format is “D”.

In one subsidiary embodiment of the above subembodiment, the third format is “U”.

In one subembodiment, the first reference signal resource comprises a CSI-RS resource.

In one subembodiment, the first reference signal resource comprises an SSB.

In one subembodiment, the first reference signal resource comprises a DMRS resource.

In one subembodiment, the first reference signal resource comprises an SRS resource.

In one subembodiment, the first reference signal resource corresponds to a TCI.

In one embodiment, the first reference signal resource corresponds to a TCI-State.

In one subembodiment, the first reference signal resource corresponds to a TCI-StateId.

In one subembodiment, the first reference signal resource corresponds to an SRI.

In one subembodiment, the first reference signal resource corresponds to a CRI.

In one subembodiment, the second reference signal resource comprises a CSI-RS resource.

In one subembodiment, the second reference signal resource comprises an SSB.

In one subembodiment, the second reference signal resource comprises a DMRS resource.

In one subembodiment, the second reference signal resource comprises an SRS resource.

In one embodiment, the second reference signal resource corresponds to a TCI.

In one subembodiment, the second reference signal resource corresponds to a TCI-State.

In one subembodiment, the second reference signal resource corresponds to a TCI-StateId.

In one subembodiment, the second reference signal resource corresponds to an SRI.

In one subembodiment, the second reference signal resource corresponds to a CRI.

In one embodiment, K1 is equal to 2, the K1 first-type reference signal resources including a first reference signal resource and a second reference signal resource; when the frequency-domain resource occupied by the first resource set belongs to a first frequency-domain resource set, the first target reference signal resource is the first reference signal resource; when the first resource set comprises a frequency-domain resource not belonging to the first frequency-domain resource set, the first target reference signal resource is the second reference signal resource.

In one subembodiment, the above phrase that the first resource set comprises a frequency-domain resource not belonging to the first frequency-domain resource set means that the frequency-domain resource occupied by the first resource set and the frequency-domain resource occupied by the first frequency-domain resource set are orthogonal.

In one embodiment, K1 is equal to 2, the K1 first-type reference signal resources including a first reference signal resource and a second reference signal resource; when a time-frequency resource occupied by the first resource set belongs to a first time-frequency resource set, the first target reference signal resource is the first reference signal resource; when the first resource set comprises a time-domain resource not belonging to the first time-frequency resource set, the first target reference signal resource is the second reference signal resource.

In one embodiment, the first format in the present application is “F”, and a format other than the first format in the present application is one of “D” or “U”.

In one embodiment, a time-domain resource corresponding to the first format in the present application supports dynamic adjustment of uplink and downlink transmission directions, and a time-domain resource corresponding to the format other than the first format in the present application does not support dynamic adjustment of the uplink and downlink transmission directions.

In one embodiment, a time-domain resource corresponding to the first format in the present application support full-duplex transmission, and a time-domain resource corresponding to the format other than the first format in the present application does not support full-duplex transmission.

In one embodiment, a time-domain resource corresponding to the first format in the present application supports dynamic adjustment of uplink and downlink transmission directions, and a time-domain resource corresponding to the format other than the first format in the present application does not support dynamic adjustment of the uplink and downlink transmission directions.

In one embodiment, the first frequency-domain resource set in the present application supports dynamic adjustment of uplink and downlink transmission directions.

In one embodiment, the first frequency-domain resource set in the present application supports Unpaired Spectrum scenarios.

In one embodiment, the first frequency-domain resource set in the present application supports Flexible Duplex frequency-domain resource configuration.

In one embodiment, the first frequency-domain resource set in the present application supports Full Duplex transmission.

In one embodiment, the first time-frequency resource set in the present application supports dynamic adjustment of uplink and downlink transmission directions.

In one embodiment, the first time-frequency resource set in the present application supports Unpaired Spectrum scenarios.

In one embodiment, the first time-frequency resource set in the present application supports Flexible Duplex frequency-domain resource configuration.

In one embodiment, the first time-frequency resource set in the present application supports Full Duplex transmission.

### Embodiment 6

Embodiment 6 illustrates another flowchart of a first information block, as shown in FIG. 6. In FIG. 6, a first node U3 and a second node N4 are in communication via a radio link. It should be particularly noted that the sequence illustrated herein does not set any limit to the signal transmission order or implementation order in the present application. In case of no conflict, the embodiments, sub-embodiments, and subsidiary embodiments in Embodiment 6 can be applied to Embodiments 5, 7, 8, 9 or 10; conversely, in case of no conflict, the embodiments, sub-embodiments, and subsidiary embodiments in Embodiments 5, 7, 8, 9 or 10 can be applied to Embodiment 6.

The first node U3 receives a first information block in step S30; and transmits a first signal in a first resource set in step S31.

The second node N4 transmits a first information block in step S40; and receives a first signal in a first resource set in step S41.

In Embodiment 6, the first information block indicates a target identity; a demodulation reference signal (DMRS) of a channel occupied by the first signal is quasi co-located with a first target reference signal resource; the target identity is associated with K1 first-type reference signal resources, and the K1 first-type reference signal resources are associated with a first cell, K1 being a positive integer greater than 1; the first target reference signal resource is one of the K1 first-type reference signal resources; a frequency-domain resource occupied by the first resource set belongs to the first cell; at least one of a time-domain resource occupied by the first resource set or the frequency-domain resource occupied by the first resource set is used to determine the first target reference signal resource from the K1 first-type reference signal resources.

### Embodiment 7

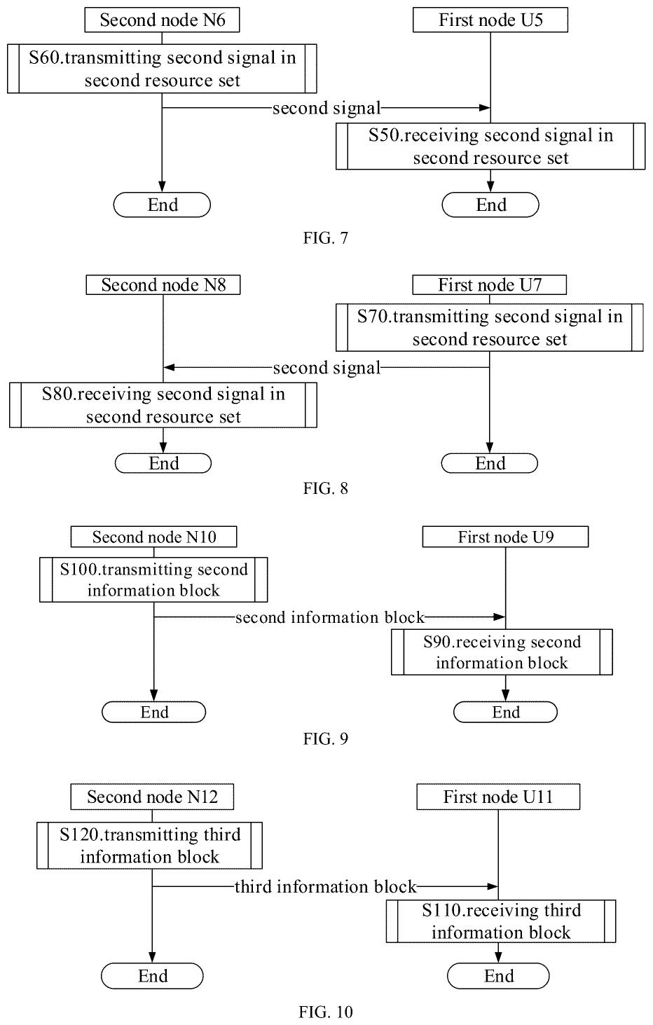

Embodiment 7 illustrates a flowchart of a second signal, as shown in FIG. 7. In FIG. 7, a first node U5 and a second node N6 are in communication via a radio link. It should be particularly noted that the sequence illustrated herein does not set any limit to the signal transmission order or implementation order in the present application. In case of no conflict, the embodiments, sub-embodiments, and subsidiary embodiments in Embodiment 7 can be applied to Embodiments 5, 6, 8, 9 or 10; conversely, in case of no conflict, the embodiments, sub-embodiments, and subsidiary embodiments in Embodiments 5, 6, 8, 9 or 10 can be applied to Embodiment 7.

The first node U5 receives a second signal in a second resource set in step S50.

The second node N6 transmits the second signal in the second resource set in step S60.

In Embodiment 7, the target identity being used to determine a second target reference signal resource, the second target reference signal resource being one of the K1 first-type reference signal resources; at least one of the time-domain resource occupied by the first resource set or the frequency-domain resource occupied by the first resource set is used to determine whether the second target reference signal resource is QCL with the first target reference signal resource.

In one embodiment, the first node receives the first signal in the first resource set and the first node receives the second signal in the second resource set.

In one subembodiment, a physical layer channel occupied by the first signal includes a PDCCH and a physical layer channel occupied by the second signal includes a PDSCH.

In one subembodiment, a physical layer channel occupied by the first signal includes a PDSCH and a physical layer channel occupied by the second signal includes a PDCCH.

In one embodiment, the first node transmits the first signal in the first resource set and the first node receives the second signal in the second resource set.

In one subembodiment, a physical layer channel occupied by the first signal includes a PUCCH and a physical layer channel occupied by the second signal includes a PDCCH.

In one subembodiment, a physical layer channel occupied by the first signal includes a PUSCH and a physical layer channel occupied by the second signal includes a PDSCH.

In one embodiment, a physical layer channel occupied by the second signal includes a PDCCH.

In one embodiment, a physical layer channel occupied by the second signal includes a PDSCH.

In one embodiment, a transport channel occupied by the second signal includes a DL-SCH.

In one embodiment, the second resource set comprises at least one of a time-domain resource, a frequency-domain resource or a code-domain resource.

In one embodiment, the second resource set comprises spatial domain resource(s).

In one embodiment, the second resource set occupies a positive integer number of REs.

In one embodiment, the second resource set occupies a positive integer number of subcarriers in frequency domain, and the second resource set occupies time-domain resource(s) corresponding to at least one OFDM symbol in time domain.

In one embodiment, the second resource set occupies at least one code-domain resource.

In one embodiment, the second resource set occupies at least one multiple access signature.

In one embodiment, a time-domain resource occupied by the first resource set is used to determine whether the second target reference signal resource is quasi-co-located with the first target reference signal resource.

In one subembodiment, a slot format employed by OFDM symbols occupied in time domain by the first resource set is a first format, and the second target reference signal resource is non-quasi-co-located (non-QCL) with the first target reference signal resource; or the slot format employed by OFDM symbols occupied in time domain by the first resource set is a format other than the first format, and the second target reference signal resource is QCL with the first target reference signal resource.

In one embodiment, a slot format employed by the first resource set in time domain and a slot format employed by the second resource set in time domain are used to determine whether the second target reference signal resource is quasi-co-located with the first target reference signal resource.

In one subembodiment, a slot format employed by OFDM symbols occupied in time domain by the first resource set and a slot format employed by OFDM symbols occupied in time domain by the second resource set are both the first format, and the second target reference signal resource is quasi co-located with the first target reference signal resource.

In one subembodiment, only one of a slot format employed by OFDM symbols occupied in time domain by the first resource set and a slot format employed by OFDM symbols occupied in time domain by the second resource set is the first format, and the second target reference signal resource is non-QCL with the first target reference signal resource.

In one subembodiment, a slot format employed by OFDM symbols occupied in time domain by the first resource set and a slot format employed by OFDM symbols occupied in time domain by the second resource set are both formats other than the first format, and the second target reference signal resource is quasi co-located with the first target reference signal resource.

In one subembodiment, a slot format employed by OFDM symbols occupied in time domain by the first resource set and a slot format employed by OFDM symbols occupied in time domain by the second resource set are identical, and the second target reference signal resource is quasi co-located with the first target reference signal resource.

In one embodiment, both a time-domain resource occupied by the first resource set and a time-domain resource occupied by the second resource set belong to a first time-domain resource set, and the second target reference signal resource is QCL with the first target reference signal resource; or a time-domain resource occupied by the first resource set and a time-domain resource occupied by the second resource set do not belong to the first time-domain resource set simultaneously, and the second target reference signal resource is non-QCL with the first target reference signal resource.

In one embodiment, a frequency-domain resource occupied by the first resource set is used to determine whether the second target reference signal resource is quasi-co-located with the first target reference signal resource.

In one embodiment, a time-frequency resource occupied by the first resource set is used to determine whether the second target reference signal resource is quasi-co-located with the first target reference signal resource.

In one embodiment, whether a frequency-domain resource occupied by the first resource set and a frequency-domain resource occupied by the second resource set both belong to a first frequency-domain resource set is used to determine whether the second target reference signal resource is quasi-co-located with the first target reference signal resource.

In one embodiment, both a frequency-domain resource occupied by the first resource set and a frequency-domain resource occupied by the second resource set belong to a first frequency-domain resource set, and the second target reference signal resource is QCL with the first target reference signal resource; or a frequency-domain resource occupied by the first resource set and a frequency-domain resource occupied by the second resource set do not belong to the first time-domain resource set simultaneously, and the second target reference signal resource is non-QCL with the first target reference signal resource.

In one embodiment, the second signal is a radio signal.

In one embodiment, the second signal is a baseband signal.

In one embodiment, the step S50 is located after the step S11 in Embodiment 5.

In one embodiment, the step S50 is located before the step S11 and after the step S10 in Embodiment 5.

In one embodiment, the step S50 is located after the step S31 in Embodiment 6.

In one embodiment, the step S50 is located before the step S31 and after the step S30 in Embodiment 6.

In one embodiment, the step S60 is located after the step S21 in Embodiment 5.

In one embodiment, the step S60 is located before the step S21 and after the step S20 in Embodiment 5.

In one embodiment, the step S60 is located after the step S41 in Embodiment 6.

In one embodiment, the step S60 is located before the step S41 and after the step S40 in Embodiment 6.

### Embodiment 8

Embodiment 8 illustrates another flowchart of a second signal, as shown in FIG. 8. In FIG. 8, a first node U7 and a second node N8 are in communication via a radio link. It should be particularly noted that the sequence illustrated herein does not set any limit to the signal transmission order or implementation order in the present application. In case of no conflict, the embodiments, sub-embodiments, and subsidiary embodiments in Embodiment 8 can be applied to Embodiments 5, 6, 7, 9 or 10; conversely, in case of no conflict, the embodiments, sub-embodiments, and subsidiary embodiments in Embodiments 5, 6, 7, 9 or 10 can be applied to Embodiment 8.

The first node U7 transmits a second signal in a second resource set in step S70.

The second node N8 receives the second signal in the second resource set in step S80.

In Embodiment 8, the target identity being used to determine a second target reference signal resource, the second target reference signal resource being one of the K1 first-type reference signal resources; at least one of the time-domain resource occupied by the first resource set or the frequency-domain resource occupied by the first resource set is used to determine whether the second target reference signal resource is QCL with the first target reference signal resource.

In one embodiment, the first node transmits the first signal in the first resource set and the first node transmits the second signal in the second resource set.

In one subembodiment, a physical layer channel occupied by the first signal includes a PUCCH and a physical layer channel occupied by the second signal includes a PUSCH.

In one subembodiment, a physical layer channel occupied by the first signal includes a PUSCH and a physical layer channel occupied by the second signal includes a PUCCH.

In one embodiment, the first node receives the first signal in the first resource set and the first node transmits the second signal in the second resource set.

In one subembodiment, a physical layer channel occupied by the first signal includes a PDCCH and a physical layer channel occupied by the second signal includes a PUCCH.

In one subembodiment, a physical layer channel occupied by the first signal includes a PDSCH and a physical layer channel occupied by the second signal includes a PUSCH.

In one embodiment, a physical layer channel occupied by the second signal includes a PUSCH.

In one embodiment, a transport channel occupied by the second signal includes a UL-SCH.

In one embodiment, the step S70 is located after the step S11 in Embodiment 5.

In one embodiment, the step S70 is located before the step S11 and after the step S10 in Embodiment 5.

In one embodiment, the step S70 is located after the step S31 in Embodiment 6.

In one embodiment, the step S70 is located before the step S31 and after the step S30 in Embodiment 6.

In one embodiment, the step S80 is located after the step S21 in Embodiment 5.

In one embodiment, the step S80 is located before the step S21 and after the step S20 in Embodiment 5.

In one embodiment, the step S80 is located after the step S41 in Embodiment 6.

In one embodiment, the step S80 is located before the step S41 and after the step S40 in Embodiment 6.

### Embodiment 9

Embodiment 9 illustrates a flowchart of a second information block, as shown in FIG. 9. In FIG. 9, a first node U9 and a second node N10 are in communication via a radio link. It should be particularly noted that the sequence illustrated herein does not set any limit to the signal transmission order or implementation order in the present application. In case of no conflict, the embodiments, sub-embodiments, and subsidiary embodiments in Embodiment 9 can be applied to Embodiments 5, 6, 7, 8 or 10; conversely, in case of no conflict, the embodiments, sub-embodiments, and subsidiary embodiments in Embodiments 5, 6, 7, 8 or 10 can be applied to Embodiment 9.

The first node U9 receives a second information block in step S90.

The second node N10 transmits a second information block in step S100.

In Embodiment 9, the second information block indicates that the first signal and the second signal use a same TCI state.

In one embodiment, the second information block is transmitted through an RRC signaling.

In one embodiment, the second information block is an RRC signaling.

In one embodiment, the second information block is a field comprised in an RRC signaling.

In one subembodiment of the above three embodiments, the RRC signaling for transmitting the second information block includes TCI in its name.

In one subembodiment of the above three embodiments, the RRC signaling for transmitting the second information block includes Unified in its name.

In one subembodiment of the above three embodiments, the RRC signaling for transmitting the second information block includes Common in its name.

In one embodiment, the second information block is transmitted via a MAC CE.

In one subembodiment of the above three embodiments, the MAC CE for transmitting the second information block includes TCI in its name.

In one subembodiment of the above three embodiments, the MAC CE for transmitting the second information block includes Unified in its name.

In one subembodiment of the above three embodiments, the MAC CE for transmitting the second information block includes Common in its name.

In one embodiment, the meaning of the above phrase that the first signal and the second signal use a same TCI state comprises that when a given TCI state is used for operating a physical layer channel occupied by the first signal, the given TCI state is also used for operating a physical layer channel occupied by the second signal; the operating includes one of indicating, updating or activating.

In one embodiment, the meaning of the above phrase that the first signal and the second signal use a same TCI state comprises that when a given TCI state is used for operating a physical layer channel occupied by the second signal, the given TCI state is also used for indicating a physical layer channel occupied by the first signal; the operating includes one of indicating, updating or activating.

In one subembodiment of the above two embodiments, the first signal and a signal transmitted in a reference signal resource associated with the given TCI state are quasi co-located.

In one subembodiment of the above two embodiments, the second signal and a signal transmitted in a reference signal resource associated with the given TCI state are quasi co-located.

In one subembodiment of the above two embodiments, a demodulation reference signal of the channel occupied by the first signal and a signal transmitted in a reference signal resource associated with the given TCI state are quasi-co-located.

In one subembodiment of the above two embodiments, a demodulation reference signal of the channel occupied by the second signal and a signal transmitted in a reference signal resource associated with the given TCI state are quasi-co-located.

In one embodiment, the meaning of the above phrase that the first signal and the second signal use a same TCI state comprises that the first signal and the second signal are quasi co-located.

In one embodiment, the meaning of the above phrase that the first signal and the second signal use a same TCI state comprises that the first signal and the second signal are quasi co-located.

In one embodiment, the meaning of the above phrase that the first signal and the second signal use a same TCI state comprises that a demodulation reference signal of the channel occupied by the first signal is quasi-co-located with a demodulation reference signal of the channel occupied by the second signal.

In one embodiment, the step S90 is located before the step S10 in Embodiment 5.

In one embodiment, the step S90 is located before the step S11 and after the step S10 in Embodiment 5.

In one embodiment, the step S90 is located before the step S30 in Embodiment 6.

In one embodiment, the step S90 is located before the step S31 and after the step S30 in Embodiment 6.

In one embodiment, the step S100 is located before the step S20 in Embodiment 5.

In one embodiment, the step S100 is located before the step S21 and after the step S20 in Embodiment 5.

In one embodiment, the step S100 is located before the step S40 in Embodiment 6.

In one embodiment, the step S100 is located before the step S41 and after the step S40 in Embodiment 6.

### Embodiment 10

Embodiment 10 illustrates a flowchart of a third information block, as shown in FIG. 10. In FIG. 10, a first node U11 and a second node N12 are in communication via a radio link. It should be particularly noted that the sequence illustrated herein does not set any limit to the signal transmission order or implementation order in the present application. In case of no conflict, the embodiments, sub-embodiments, and subsidiary embodiments in Embodiment 10 can be applied to Embodiments 5, 6, 7, 8 or 9; conversely, in case of no conflict, the embodiments, sub-embodiments, and subsidiary embodiments in Embodiments 5, 6, 7, 8 or 9 can be applied to Embodiment 10.

The first node U11 receives a third information block in step S110.

The second node N12 transmits a third information block in step S120.

In Embodiment 10, the third information block indicates M1 candidate reference signal resource pools, the M1 candidate reference signal resource pools respectively corresponding to M1 first-type identities, the target identity being one of the M1 first-type identities; the target identity is used to determine a target candidate reference signal resource pool from the M1 candidate reference signal resource pools, the target candidate reference signal resource pool comprising the Q1 candidate reference signal resource sets; M1 is a positive integer greater than 1.

In one embodiment, the third information block is transmitted through an RRC signaling.

In one embodiment, the third information block is an RRC signaling.

In one embodiment, the third information block is a field comprised in an RRC signaling.

In one subembodiment of the above three embodiments, the RRC signaling for transmitting the third information block includes TCI in its name.

In one subembodiment of the above three embodiments, the RRC signaling for transmitting the third information block includes Unified in its name.

In one subembodiment of the above three embodiments, the RRC signaling for transmitting the third information block includes Common in its name.

In one embodiment, the third information block is transmitted via a MAC CE.

In one subembodiment of the above three embodiments, the RRC signaling for transmitting the third information block includes TCI in its name.

In one subembodiment of the above three embodiments, the RRC signaling for transmitting the third information block includes Unified in its name.

In one subembodiment of the above three embodiments, the RRC signaling for transmitting the third information block includes Common in its name.

In one embodiment, any one of the M1 candidate reference signal resource pools comprises Q3 candidate reference signal resource sets, the Q3 candidate reference signal resource sets being associated with the Q2 cell; Q3 being a positive integer greater than 1.

In one subembodiment, Q3 is equal to Q1.

In one subembodiment, Q3 is equal to Q2.

In one subembodiment, any one of the Q3 candidate reference signal resource sets comprises a plurality of candidate reference signal resources, and any of the plurality of candidate reference signal resources comprises at least one of a CSI-RS resource or an SSB.

In one subembodiment, any one of the Q3 candidate reference signal resource sets comprises a plurality of candidate reference signal resources, and any of the plurality of candidate reference signal resources comprises a DMRS resource or an SRS resource.

In one embodiment, M1 is equal to one of 2, 4, 8, 16, 32 or 64.

In one embodiment, any of the M1 first-type identities is a non-negative integer.

In one embodiment, any of the M1 first-type identities is a TCI state.

In one embodiment, any of the M1 first-type identities is a TCI state index.

In one embodiment, any of the M1 first-type identities is a TCI state ID.

In one embodiment, any of the M1 first-type identities is a TCI-StateId.

In one embodiment, any of the M1 first-type identities is a CRI.

In one embodiment, any of the M1 first-type identities is an SRI.

In one embodiment, the step S110 is located before the step S10 in Embodiment 5.

In one embodiment, the step S110 is located before the step S11 and after the step S10 in Embodiment 5.

In one embodiment, the step S110 is located before the step S30 in Embodiment 6.

In one embodiment, the step S110 is located before the step S31 and after the step S30 in Embodiment 6.

In one embodiment, the step S120 is located before the step S20 in Embodiment 5.

In one embodiment, the step S120 is located before the step S21 and after the step S20 in Embodiment 5.

In one embodiment, the step S120 is located before the step S40 in Embodiment 6.

In one embodiment, the step S120 is located before the step S41 and after the step S40 in Embodiment 6.

In one embodiment, the step S110 is located before the step S90 in Embodiment 9.

In one embodiment, the step S110 is located after the step S90 in Embodiment 9.

In one embodiment, the step S120 is located before the step S100 in Embodiment 9.

In one embodiment, the step S120 is located after the step S100 in Embodiment 9.

### Embodiment 11

Embodiment 11 illustrates a schematic diagram of K1 first-type reference signal resources, as shown in FIG. 11. In FIG. 11, each of the K1 first-type reference signal resources is associated with a TCI-State.

In one embodiment, the K1 first-type reference signal resources respectively correspond to K1 different QCL relationships.

In one embodiment, the K1 first-type reference signal resources respectively correspond to K1 reception beamforming vectors.

In one embodiment, the K1 first-type reference signal resources respectively correspond to K1 transmission beamforming vectors.

In one embodiment, any of the K1 first-type reference signal resources occupies more than one Resource Element (RE).

### Embodiment 12

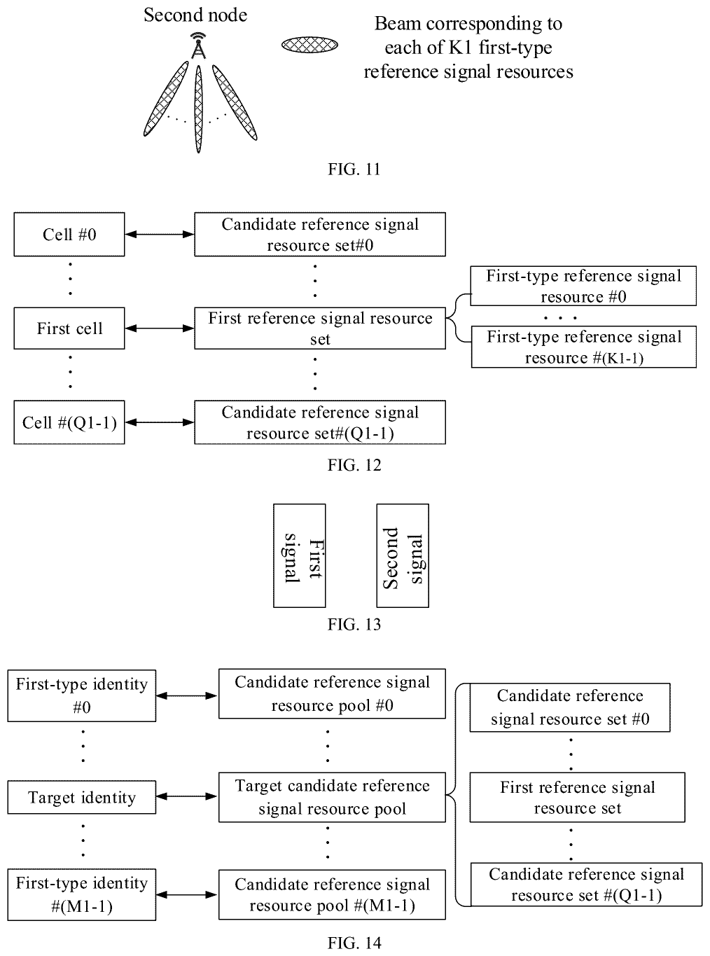

Embodiment 12 illustrates a schematic diagram of Q1 candidate reference signal resource sets, as shown in FIG. 12. In FIG. 12, the Q1 candidate reference signal resource sets are respectively associated with Q1 cells; candidate reference signal resources included in any of the Q1 candidate reference signal resource sets can be indicated by an identical TCI-StateId.

The candidate reference signal resource sets #0 to #(Q1-1) shown in FIG. 12 correspond to Q1 candidate reference signal resource sets, and Cell #0 to Cell #(Q1-1) shown in FIG. 12 correspond to Q1 Cells; the first reference signal resource sets of the present application is one of the candidate reference signal resource sets #0 through #(Q1-1), and the first reference signal resource set comprises K1 first-type reference signal resources, respectively corresponding to first-type reference signal resources #0 to #(K1-1) in this figure.

### Embodiment 13

Embodiment 13 illustrates a schematic diagram of a first signal and a second signal, as shown in FIG. 13. In FIG. 13, the first signal and the second signal each occupy orthogonal time-frequency resources.

In one embodiment, REs occupied by the first signal and REs occupied by the second signal are orthogonal.

In one embodiment, the first signal and the second signal are Time Division Multiplexing (TDM).

In one embodiment, the first signal and the second signal are Frequency Division Multiplexing (FDM).

In one embodiment, when a QCL relationship employed by the first signal is indicated by the first information block in this application, no additional information needs to be employed to indicate a QCL relationship employed by the second signal.

In one embodiment, when a TCI-StateId employed by the first signal is indicated by the first information block in this application, there is no need to employ additional information to indicate a TCI-StateId employed by the second signal.

In one embodiment, time-domain resources occupied by the first signal are located before time-domain resources occupied by the second signal.

In one embodiment, there is an overlap between time-domain resources occupied by the first signal and time-domain resources occupied by the second signal, and the first signal and the second signal each occupy different frequency-domain resources.

In one embodiment, the first signal is used to schedule the second signal.

In one embodiment, the first signal is used to indicate time-frequency resources occupied by the second signal.

In one embodiment, the first signal is used to indicate a Hybrid Automatic Repeat reQuest (HARQ) process number occupied by the second signal.

In one subembodiment of the above three embodiments, no TCI field is present in the first signal.

### Embodiment 14

Embodiment 14 illustrates a schematic diagram of M1 candidate reference signal resource pools, as shown in FIG. 14. In FIG. 14, the M1 candidate reference signal resource pools respectively correspond to M1 first-type identities, the M1 first-type identities corresponding to M1 TCI-StateIds; the target identity is one of the M1 first-type identities; the target identity is used to determine a target candidate reference signal resource pool from the M1 candidate reference signal resource pools, the target candidate reference signal resource pool comprising the Q1 candidate reference signal resource sets; the M1 first-type identities shown in this figure are first-type identities #0 to #(M1-1), and the M1 candidate reference signal resource pools shown in this figure are candidate reference signal resource pools #0 to #(M1-1).

### Embodiment 15

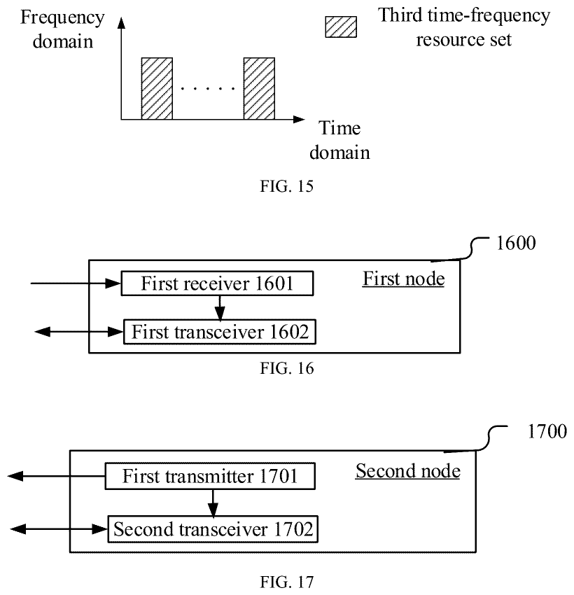

Embodiment 15 illustrates a schematic of an application scenario of the present application, as shown in FIG. 15. In FIG. 15, a third time-frequency resource set is configured via RRC signaling or Media Access Control (MAC) Control Elements (CE); the third time-frequency resource set is capable of supporting dynamic adjustment of the uplink and downlink transmission directions; and whether the first resource set belongs to the third time-frequency resource set is used to determine the first target reference signal resource from the K1 first-type reference signal resources.

In one embodiment, the K1 first-type reference signal resources include a first reference signal resource and a second reference signal resource; when the first resource set belongs to the third time-frequency resource set, the first target reference signal resource is the first reference signal resource; when the first resource set does not belong to the third time-frequency resource set, the first target reference signal resource is the second reference signal resource.

In one embodiment, time-domain resources occupied by the third time-frequency resource set belong to the first time-domain resource set in the present application.

In one embodiment, frequency-domain resources occupied by the third time-frequency resource set belong to the first frequency-domain resource set in the present application.

In one embodiment, frequency-domain resources occupied by the third time-frequency resource set belong to the first frequency-domain resource set in the present application.

In one embodiment, REs occupied by the third time-frequency resource set belong to the first time-frequency resource set in the present application.

In one embodiment, the third time-frequency resource set occupies more than one RE.

In one embodiment, the third time-frequency resource set occupies more than one slot in time domain.

In one embodiment, the third time-frequency resource set occupies more than one OFDM symbol in time domain.

In one embodiment, the third time-frequency resource set occupies frequency-domain resources corresponding to more than one Resource Block (RB).

In one embodiment, the time-domain resource in the present application comprises at least one of OFDM symbol, slot or subframe.

In one embodiment, the frequency-domain resource in the present application comprises at least one of subcarrier, RB, RB set or BWP.

In one embodiment, the time-domain resource in the present application comprises RE or RE set.

### Embodiment 16

Embodiment 16 illustrates a structure block diagram of a first node, as shown in FIG. 16. In FIG. 16, a first node 1600 comprises a first receiver 1601 and a first transceiver 1602.

The first receiver 1601 receives a first information block, the first information block indicating a target identity;

the first transceiver 1602 receives a first signal in a first resource set, or transmits a first signal in a first resource set, with a demodulation reference signal (DMRS) of a channel occupied by the first signal being quasi co-located with a first target reference signal resource.

In Embodiment 16, the target identity is associated with K1 first-type reference signal resources, and the K1 first-type reference signal resources are associated with a first cell, K1 being a positive integer greater than 1; the first target reference signal resource is one of the K1 first-type reference signal resources; a frequency-domain resource occupied by the first resource set belongs to the first cell; at least one of a time-domain resource occupied by the first resource set or the frequency-domain resource occupied by the first resource set is used to determine the first target reference signal resource from the K1 first-type reference signal resources.

In one embodiment, the target identity is associated with any candidate reference signal resource set of Q1 candidate reference signal resource sets, the Q1 candidate reference signal resource sets being associated with Q2 cells; a first reference signal resource set comprises the K1 first-type reference signal resources; the first reference signal resource set is one of the Q1 candidate reference signal resource sets; the first resource set is used to determine the first reference signal resource set from the Q1 candidate reference signal resource sets; Q1 is a positive integer greater than 1, and Q2 is a positive integer greater than 1.

In one embodiment, the first transceiver 1602 receives the second signal in the second resource set; the target identity being used to determine a second target reference signal resource, the second target reference signal resource being one of the K1 first-type reference signal resources; at least one of the time-domain resource occupied by the first resource set or the frequency-domain resource occupied by the first resource set is used to determine whether the second target reference signal resource is QCL with the first target reference signal resource.

In one embodiment, the first transceiver 1602 transmits the second signal in the second resource set; the target identity being used to determine a second target reference signal resource, the second target reference signal resource being one of the K1 first-type reference signal resources; at least one of the time-domain resource occupied by the first resource set or the frequency-domain resource occupied by the first resource set is used to determine whether the second target reference signal resource is QCL with the first target reference signal resource.

In one embodiment, there exist a first physical channel and a second physical channel respectively in two different cells among the Q2 cells, and a same TCI state ID is used to indicate or update or activate a QCL parameter of the first physical channel or a QCL parameter of the second physical channel; the first physical channel and the second physical channel are both PDCCHs or the first physical channel and the second physical channel are both PDSCHs, or, the first physical channel and the second physical channel are both PUCCHs or the first physical channel and the second physical channel are both PUSCHs.

In one embodiment, the first receiver 1601 receives a second information block, the second information block indicating that the first signal and the second signal use a same TCI state.

In one embodiment, K1 is equal to 2, the K1 first-type reference signal resources including a first reference signal resource and a second reference signal resource; the time-domain resource occupied by the first resource set comprises a first symbol set; when a slot format used by a symbol in the first symbol set is a first format, the first target reference signal resource is the first reference signal resource; when a slot format used by a symbol in the first symbol set is a format other than the first format, the first target reference signal resource is the second reference signal resource.

In one embodiment, K1 is equal to 2, the K1 first-type reference signal resources including a first reference signal resource and a second reference signal resource; when the frequency-domain resource occupied by the first resource set belongs to a first frequency-domain resource set, the first target reference signal resource is the first reference signal resource; when the first resource set comprises a frequency-domain resource not belonging to the first frequency-domain resource set, the first target reference signal resource is the second reference signal resource.

In one embodiment, K1 is equal to 2, the K1 first-type reference signal resources including a first reference signal resource and a second reference signal resource; when a time-frequency resource occupied by the first resource set belongs to a first time-frequency resource set, the first target reference signal resource is the first reference signal resource; when the first resource set comprises a time-frequency resource not belonging to the first time-frequency resource set, the first target reference signal resource is the second reference signal resource.

In one embodiment, the first receiver 1601 receives a third information block, the third information block indicating M1 candidate reference signal resource pools; the M1 candidate reference signal resource pools respectively correspond to M1 first-type identities, the target identity being one of the M1 first-type identities; the target identity is used to determine a target candidate reference signal resource pool from the M1 candidate reference signal resource pools, the target candidate reference signal resource pool comprising the Q1 candidate reference signal resource sets; M1 is a positive integer greater than 1.

In one embodiment, the first receiver 1601 comprises at least the first four of the antenna 452, the receiver 454, the multi-antenna receiving processor 458, the receiving processor 456 and the controller/processor 459 in Embodiment 4.

In one embodiment, the first transceiver 1602 comprises at least the first six of the antenna 452, the receiver/transmitter 454, the multi-antenna receiving processor 458, the multi-antenna transmitting processor 457, the receiving processor 456, the transmitting processor 468 and the controller/processor 459 in Embodiment 4.

In one embodiment, the first information block is a TCI field in a DCI; the target identity is a TCI-StateId; a physical layer channel occupied by the first signal is a PDSCH or a PUSCH; the K1 first-type reference signal resources are associated with at least either of K1 CSI-RS resources or K1 SSBs, respectively.

In one embodiment, the first information block is a field in a MAC CE or an RRC signaling; the target identity is a TCI-StateId; a physical layer channel occupied by the first signal is a PDCCH or a PUCCH; the K1 first-type reference signal resources are associated with at least either of K1 CSI-RS resources or K1 SSBs, respectively.

### Embodiment 17

Embodiment 17 illustrates a structure block diagram of a second node, as shown in FIG. 17. In FIG. 17, a second node 1700 comprises a first transmitter 1701 and a second transceiver 1702.

The first transmitter 1701 transmits a first information block, the first information block indicating a target identity;

the second transceiver 1702 transmits a first signal in a first resource set, or receives a first signal in a first resource set, with a demodulation reference signal (DMRS) of a channel occupied by the first signal being quasi co-located with a first target reference signal resource.

In Embodiment 17, the target identity is associated with K1 first-type reference signal resources, and the K1 first-type reference signal resources are associated with a first cell, K1 being a positive integer greater than 1; the first target reference signal resource is one of the K1 first-type reference signal resources; a frequency-domain resource occupied by the first resource set belongs to the first cell; at least one of a time-domain resource occupied by the first resource set or the frequency-domain resource occupied by the first resource set is used to determine the first target reference signal resource from the K1 first-type reference signal resources.

In one embodiment, the target identity is associated with any candidate reference signal resource set of Q1 candidate reference signal resource sets, the Q1 candidate reference signal resource sets being associated with Q2 cells; a first reference signal resource set comprises the K1 first-type reference signal resources; the first reference signal resource set is one of the Q1 candidate reference signal resource sets; the first resource set is used to determine the first reference signal resource set from the Q1 candidate reference signal resource sets; Q1 is a positive integer greater than 1, and Q2 is a positive integer greater than 1.

In one embodiment, the second transceiver 1702 transmits the second signal in the second resource set; the target identity being used to determine a second target reference signal resource, the second target reference signal resource being one of the K1 first-type reference signal resources; at least one of the time-domain resource occupied by the first resource set or the frequency-domain resource occupied by the first resource set is used to determine whether the second target reference signal resource is QCL with the first target reference signal resource.

In one embodiment, the second transceiver 1702 receives the second signal in the second resource set; the target identity being used to determine a second target reference signal resource, the second target reference signal resource being one of the K1 first-type reference signal resources; at least one of the time-domain resource occupied by the first resource set or the frequency-domain resource occupied by the first resource set is used to determine whether the second target reference signal resource is QCL with the first target reference signal resource.

In one embodiment, there exist a first physical channel and a second physical channel respectively in two different cells among the Q2 cells, and a same TCI state ID is used to indicate or update or activate a QCL parameter of the first physical channel or a QCL parameter of the second physical channel; the first physical channel and the second physical channel are both PDCCHs or the first physical channel and the second physical channel are both PDSCHs, or, the first physical channel and the second physical channel are both PUCCHs or the first physical channel and the second physical channel are both PUSCHs.

In one embodiment, the first transmitter 1701 transmits a second information block; the second information block indicates that the first signal and the second signal use a same TCI state.

In one embodiment, K1 is equal to 2, the K1 first-type reference signal resources including a first reference signal resource and a second reference signal resource; the time-domain resource occupied by the first resource set comprises a first symbol set; when a slot format used by a symbol in the first symbol set is a first format, the first target reference signal resource is the first reference signal resource; when a slot format used by a symbol in the first symbol set is a format other than the first format, the first target reference signal resource is the second reference signal resource.

In one embodiment, K1 is equal to 2, the K1 first-type reference signal resources including a first reference signal resource and a second reference signal resource; when the frequency-domain resource occupied by the first resource set belongs to a first frequency-domain resource set, the first target reference signal resource is the first reference signal resource; when the first resource set comprises a frequency-domain resource not belonging to the first frequency-domain resource set, the first target reference signal resource is the second reference signal resource.

In one embodiment, the first transmitter 1701 transmits a third information block; the third information block indicates M1 candidate reference signal resource pools, the M1 candidate reference signal resource pools respectively corresponding to M1 first-type identities, the target identity being one of the M1 first-type identities; the target identity is used to determine a target candidate reference signal resource pool from the M1 candidate reference signal resource pools, the target candidate reference signal resource pool comprising the Q1 candidate reference signal resource sets; M1 is a positive integer greater than 1.

In one embodiment, the first transmitter 1701 comprises at least the first four of the antenna 420, the transmitter 418, the multi-antenna transmitting processor 471, the transmitting processor 416 and the controller/processor 475 in Embodiment 4.

In one embodiment, the second transceiver 1702 comprises at least the first six of the antenna 420, the transmitter/receiver 418, the multi-antenna transmitting processor 471, the multi-antenna receiving processor 472, the transmitting processor 416, the receiving processor 470 and the controller/processor 475 in Embodiment 4.

In one embodiment, the first information block is a TCI field in a DCI; the target identity is a TCI-StateId; a physical layer channel occupied by the first signal is a PDSCH or a PUSCH; the K1 first-type reference signal resources are associated with at least either of K1 CSI-RS resources or K1 SSBs, respectively.

In one embodiment, the first information block is a field in a MAC CE or an RRC signaling; the target identity is a TCI-StateId; a physical layer channel occupied by the first signal is a PDCCH or a PUCCH; the K1 first-type reference signal resources are associated with at least either of K1 CSI-RS resources or K1 SSBs, respectively.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The first node in the present application includes but is not limited to mobile phones, tablet computers, notebooks, network cards, low-consumption equipment, enhanced MTC (eMTC) terminals, NB-IOT terminals, vehicle-mounted communication equipment, vehicles, automobiles, RSU, aircrafts, airplanes, unmanned aerial vehicles, telecontrolled aircrafts, etc. The second node in the present application includes but is not limited to macro-cellular base stations, micro-cellular base stations, home base stations, relay base station, eNB, gNB, Transmitter Receiver Point (TRP), GNSS, relay satellite, satellite base station, airborne base station, RSU, unmanned ariel vehicle, test equipment like transceiving device simulating partial functions of base station or signaling tester, and other radio communication equipment.

It will be appreciated by those skilled in the art that this invention can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first information block, the first information block indicating a target identity; and
a first transceiver, receiving a first signal in a first resource set, or transmitting a first signal in a first resource set, with a demodulation reference signal (DMRS) of a channel occupied by the first signal being quasi co-located with a first target reference signal resource;
wherein the target identity is associated with K1 first-type reference signal resources, and the K1 first-type reference signal resources are associated with a first cell, K1 being a positive integer greater than 1; the first target reference signal resource is one of the K1 first-type reference signal resources; a frequency-domain resource occupied by the first resource set belongs to the first cell; at least one of a time-domain resource occupied by the first resource set or the frequency-domain resource occupied by the first resource set is used to determine the first target reference signal resource from the K1 first-type reference signal resources.

2. The first node according to claim 1, characterized in that the target identity is associated with any candidate reference signal resource set of Q1 candidate reference signal resource sets, the Q1 candidate reference signal resource sets being associated with Q2 cells; a first reference signal resource set comprises the K1 first-type reference signal resources; the first reference signal resource set is one of the Q1 candidate reference signal resource sets; the first resource set is used to determine the first reference signal resource set from the Q1 candidate reference signal resource sets; Q1 is a positive integer greater than 1, and Q2 is a positive integer greater than 1.

3. The first node according to claim 1, characterized in that the first transceiver receives or transmits a second signal in a second resource set, the target identity being used to determine a second target reference signal resource, the second target reference signal resource being one of the K1 first-type reference signal resources; at least one of the time-domain resource occupied by the first resource set or the frequency-domain resource occupied by the first resource set is used to determine whether the second target reference signal resource is QCL with the first target reference signal resource.

4. The first node according to claim 2, characterized in that there exist a first physical channel and a second physical channel respectively in two different cells among the Q2 cells, and a same TCI state ID is used to indicate or update or activate a QCL parameter of the first physical channel or a QCL parameter of the second physical channel; the first physical channel and the second physical channel are both PDCCHs or the first physical channel and the second physical channel are both PDSCHs, or, the first physical channel and the second physical channel are both PUCCHs or the first physical channel and the second physical channel are both PUSCHs.

5. The first node according to claim 3, characterized in that the first receiver receives a second information block, the second information block indicating that the first signal and the second signal use a same TCI state.

6. The first node according to claim 1, characterized in that K1 is equal to 2, the K1 first-type reference signal resources including a first reference signal resource and a second reference signal resource; the time-domain resource occupied by the first resource set comprises a first symbol set; when a slot format used by a symbol in the first symbol set is a first format, the first target reference signal resource is the first reference signal resource; when a slot format used by a symbol in the first symbol set is a format other than the first format, the first target reference signal resource is the second reference signal resource.

7. The first node according to claim 1, characterized in that K1 is equal to 2, the K1 first-type reference signal resources including a first reference signal resource and a second reference signal resource; when the frequency-domain resource occupied by the first resource set belongs to a first frequency-domain resource set, the first target reference signal resource is the first reference signal resource; when the first resource set comprises a frequency-domain resource not belonging to the first frequency-domain resource set, the first target reference signal resource is the second reference signal resource.

8. The first node according to claim 1, characterized in that the first receiver receives a third information block, the third information block indicating M1 candidate reference signal resource pools, the M1 candidate reference signal resource pools respectively corresponding to M1 first-type identities, the target identity being one of the M1 first-type identities; the target identity is used to determine a target candidate reference signal resource pool from the M1 candidate reference signal resource pools, the target candidate reference signal resource pool comprising the Q1 candidate reference signal resource sets; M1 is a positive integer greater than 1.

9. A second node for wireless communications, comprising:
a first transmitter, transmitting a first information block, the first information block indicating a target identity; and
a second transceiver, transmitting a first signal in a first resource set, or receiving a first signal in a first resource set, with a demodulation reference signal (DMRS) of a channel occupied by the first signal being quasi co-located with a first target reference signal resource;
wherein the target identity is associated with K1 first-type reference signal resources, and the K1 first-type reference signal resources are associated with a first cell, K1 being a positive integer greater than 1; the first target reference signal resource is one of the K1 first-type reference signal resources; a frequency-domain resource occupied by the first resource set belongs to the first cell; at least one of a time-domain resource occupied by the first resource set or the frequency-domain resource occupied by the first resource set is used to determine the first target reference signal resource from the K1 first-type reference signal resources.

10. The second node according to claim 9, characterized in that the target identity is associated with any candidate reference signal resource set of Q1 candidate reference signal resource sets, the Q1 candidate reference signal resource sets being associated with Q2 cells; a first reference signal resource set comprises the K1 first-type reference signal resources; the first reference signal resource set is one of the Q1 candidate reference signal resource sets; the first resource set is used to determine the first reference signal resource set from the Q1 candidate reference signal resource sets; Q1 is a positive integer greater than 1, and Q2 is a positive integer greater than 1.

11. The second node according to claim 9, characterized in that the second transceiver transmits or receives a second signal in a second resource set, the target identity being used to determine a second target reference signal resource, the second target reference signal resource being one of the K1 first-type reference signal resources; at least one of the time-domain resource occupied by the first resource set or the frequency-domain resource occupied by the first resource set is used to determine whether the second target reference signal resource is QCL with the first target reference signal resource.

12. The second node according to claim 10, characterized in that there exist a first physical channel and a second physical channel respectively in two different cells among the Q2 cells, and a same TCI state ID is used to indicate or update or activate a QCL parameter of the first physical channel or a QCL parameter of the second physical channel; the first physical channel and the second physical channel are both PDCCHs or the first physical channel and the second physical channel are both PDSCHs, or, the first physical channel and the second physical channel are both PUCCHs or the first physical channel and the second physical channel are both PUSCHs.

13. The second node according to claim 11, characterized in that the first transmitter transmits a second information block, the second information block indicating that the first signal and the second signal use a same TCI state.

14. The second node according to claim 9, characterized in that K1 is equal to 2, the K1 first-type reference signal resources including a first reference signal resource and a second reference signal resource; the time-domain resource occupied by the first resource set comprises a first symbol set; when a slot format used by a symbol in the first symbol set is a first format, the first target reference signal resource is the first reference signal resource; when a slot format used by a symbol in the first symbol set is a format other than the first format, the first target reference signal resource is the second reference signal resource.

15. The second node according to claim 9, characterized in that K1 is equal to 2, the K1 first-type reference signal resources including a first reference signal resource and a second reference signal resource; when the frequency-domain resource occupied by the first resource set belongs to a first frequency-domain resource set, the first target reference signal resource is the first reference signal resource; when the first resource set comprises a frequency-domain resource not belonging to the first frequency-domain resource set, the first target reference signal resource is the second reference signal resource.

16. The second node according to claim 9, characterized in that the first transmitter transmits a third information block, the third information block indicating M1 candidate reference signal resource pools, the M1 candidate reference signal resource pools respectively corresponding to M1 first-type identities, the target identity being one of the M1 first-type identities; the target identity is used to determine a target candidate reference signal resource pool from the M1 candidate reference signal resource pools, the target candidate reference signal resource pool comprising the Q1 candidate reference signal resource sets; M1 is a positive integer greater than 1.

17. A method in a first node for wireless communications, comprising:
receiving a first information block, the first information block indicating a target identity; and
receiving a first signal in a first resource set, or transmitting a first signal in a first resource set, with a demodulation reference signal (DMRS) of a channel occupied by the first signal being quasi co-located with a first target reference signal resource;
wherein the target identity is associated with K1 first-type reference signal resources, and the K1 first-type reference signal resources are associated with a first cell, K1 being a positive integer greater than 1; the first target reference signal resource is one of the K1 first-type reference signal resources; a frequency-domain resource occupied by the first resource set belongs to the first cell; at least one of a time-domain resource occupied by the first resource set or the frequency-domain resource occupied by the first resource set is used to determine the first target reference signal resource from the K1 first-type reference signal resources.

18. The method in the first node according to claim 17, characterized in that the target identity is associated with any candidate reference signal resource set of Q1 candidate reference signal resource sets, the Q1 candidate reference signal resource sets being associated with Q2 cells; a first reference signal resource set comprises the K1 first-type reference signal resources; the first reference signal resource set is one of the Q1 candidate reference signal resource sets; the first resource set is used to determine the first reference signal resource set from the Q1 candidate reference signal resource sets; Q1 is a positive integer greater than 1, and Q2 is a positive integer greater than 1.

19. The method in the first node according to claim 17, characterized in comprising:
receiving or transmitting a second signal in a second resource set;
wherein the target identity being used to determine a second target reference signal resource, the second target reference signal resource being one of the K1 first-type reference signal resources; at least one of the time-domain resource occupied by the first resource set or the frequency-domain resource occupied by the first resource set is used to determine whether the second target reference signal resource is QCL with the first target reference signal resource.

20. The method in the first node according to claim 18, characterized in that there exist a first physical channel and a second physical channel respectively in two different cells among the Q2 cells, and a same TCI state ID is used to indicate or update or activate a QCL parameter of the first physical channel or a QCL parameter of the second physical channel; the first physical channel and the second physical channel are both PDCCHs or the first physical channel and the second physical channel are both PDSCHs, or, the first physical channel and the second physical channel are both PUCCHs or the first physical channel and the second physical channel are both PUSCHs.
